(19) United States
(12) Patent Application Publication
(10) Pub. No.: US 2015/0254886 A1
(43) Pub. Date: Sep. 10, 2015

(54) SYSTEM AND METHOD FOR GENERATING ANIMATED CONTENT

(71) Applicant: UTW TECHNOLOGY CO., LTD., TAIPEI (TW)

(72) Inventor: YU-HSIEN LI, TAIPEI (TW)

(21) Appl. No.: 14/319,279

(22) Filed: Jun. 30, 2014

Related U.S. Application Data
(63) Continuation-in-part of application No. 14/200,120, filed on Mar. 7, 2014.
Application No. 14/200,120 is a continuation-in-part of application No. 14/200,137, filed on Mar. 7, 2014.

(51) Int. Cl. G06T 13/40; G06T 11/60

(52) U.S. Cl. CPC G06T 13/40; G06T 11/60

(57) ABSTRACT

A method for generating an animated content is provided. The method comprises receiving a first base headshot photo, the first base headshot photo exhibiting a first emotion; receiving a second base headshot photo, the second base headshot photo exhibiting a second emotion different from the first emotion; generating a first derivative headshot photo by adjusting a facial feature of the first base headshot photo; generating a second derivative headshot photo by adjusting a facial feature of the second base headshot photo; forming a first set of photos by selecting photos from the first base headshot photo, the second base headshot photo, the first derivative headshot photo and the second derivative headshot photo; and generating a first animated content based on the first set of photos.

### RELATED APPLICATIONS

This application claims priority to U.S. Utility patent application Ser. No. 14/200,137, filed on Mar. 7, 2014 and entitled “METHOD AND SYSTEM FOR MODELING EMOTION,” and to U.S. Utility patent application Ser. No. 14/200,120, filed on Mar. 7, 2014 and entitled “SYSTEM AND METHOD FOR GENERATING ANIMATED CONTENT.” These applications are incorporated herein by reference.

### BACKGROUND

The popularity of the Internet as well as consumer electronic devices has experienced an exponential growth in the past decade. As the bandwidth of the Internet becomes broader, transmission of information and electronic data over the Internet becomes faster. Moreover, as electronic devices become smaller and lighter, and stronger in processing power, different kinds of tasks can be performed more efficiently at whatever places a user chooses. These technical developments pave the way for one of the most fast-growing services in the Internet age, electronic content sharing.

Electronic content sharing allows people to express their feelings, thoughts or emotions to others. One example of electronic content sharing is to upload texts, photos or videos to a publically accessible website. Through the published electronic contents, each individual on the Internet is able to tell the world anything, for example, that he/she felt excited as he/she went jogging for 5 miles yesterday, that he/she feels happy as of this moment, or that he/she feels annoyed about the business trip tomorrow. Consequently, electronic content sharing has become a social networking tool. Ordinarily, people share their thoughts through words, and in the scenario of electronic content sharing, such words may be further stylized, e.g. bold or italicized. Alternatively, people may choose to share their emotions through pictures (or stickers or photos) because a picture can express more than a thousand words can do. Ways to improve expression of feelings, thoughts or emotions for electronic content sharing are continuingly being sought.

### BRIEF DESCRIPTION OF THE DRAWINGS

One or more embodiments are illustrated by way of example and, not by limitation, in the figures of the accompanying drawings, elements having the same reference numeral designations represent like elements throughout. The drawings are not drawn to scale, unless otherwise disclosed.

FIG. 1 is a schematic view of a social networking system in accordance with some embodiments of the present disclosure.

FIG. 2 is a flow chart of operations of the social networking system in accordance with some embodiments of the present disclosure.

FIGS. 3A-3C illustrate graphical user interface (GUI) display at the social networking system in accordance with some embodiments of the present disclosure.

FIG. 4 illustrates GUI display at the social networking system in accordance with some embodiments of the present disclosure.

FIGS. 5A-5C illustrate GUI display at the social networking system in accordance with some embodiments of the present disclosure.

FIGS. 6A-6C illustrate interactions at the social networking system in accordance with some embodiments of the present disclosure.

FIGS. 7A and 7B illustrate GUI display at the social networking system in accordance with some embodiments of the present disclosure.

FIG. 8 illustrates a method for modeling emotions in animation in accordance with some embodiments of the present disclosure.

FIGS. 9A-9C illustrate GUI display at the social networking system in accordance with some embodiments of the present disclosure.

FIGS. 10A and 10B are schematic views of a system for generating an animated content in accordance with some embodiments of the present disclosure.

FIG. 11 is a flow chart of operations of the system for generating an animated content in accordance with some embodiments of the present disclosure.

FIGS. 12A-12D illustrate GUI display at the system for generating an animated content in accordance with some embodiments of the present disclosure.

FIGS. 13A and 13B illustrate interactions of the method for generating an animated content at a system in accordance with some embodiments of the present disclosure.

FIGS. 14A and 14B illustrate the GUI display at a system for generating an animated content in accordance with some embodiments of the present disclosure.

FIG. 15 is a flow chart of operations of the system for generating an animated content in accordance with some embodiments of the present disclosure.

FIGS. 16A-16J illustrate a method for generating an animated content in accordance with some embodiments of the present disclosure.

FIGS. 17A and 17B illustrate additional characteristics for a base headshot photo, in accordance with some embodiments of the present disclosure.

Like Reference Symbols in the Various Drawings Indicate Like Elements.

### DETAILED DESCRIPTION OF THE DISCLOSURE

The following disclosure provides many different embodiments, or examples, for implementing different features of the provided subject matter. Any alterations and modifications in the described embodiments, and any further applications of principles described in this document are contemplated as would normally occur to one of ordinary skill in the art to which the disclosure relates. Specific examples of components and arrangements are described below to simplify the present disclosure. These are, of course, merely examples and are not intended to be limiting. For example, when an element is referred to as being “connected to” or “coupled to” another element, it may be directly connected to or coupled to the other element, or intervening elements may be present.

Throughout the various views and illustrative embodiments, like reference numerals and/or letters are used to designate like elements. Reference will now be made in detail to exemplary embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, an apparatus in accordance with the present disclosure. It is to be understood that elements not specifically shown or described may take various forms. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. It should be appreciated that the following figures are not drawn to scale; rather, these figures are merely intended for illustration.

In the drawings, the figures are not necessarily drawn to scale, and in some instances the drawings have been exaggerated and/or simplified in places for illustrative purposes. One of ordinary skill in the art will appreciate the many possible applications and variations of the present disclosure based on the following illustrative embodiments of the present disclosure.

It will be understood that singular forms “a”, “an” and “the” are intended to include the plural forms as well, unless the context clearly indicates otherwise. Furthermore, relative terms, such as “bottom” and “top,” may be used herein to describe one element's relationship to other elements as illustrated in the Figures.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

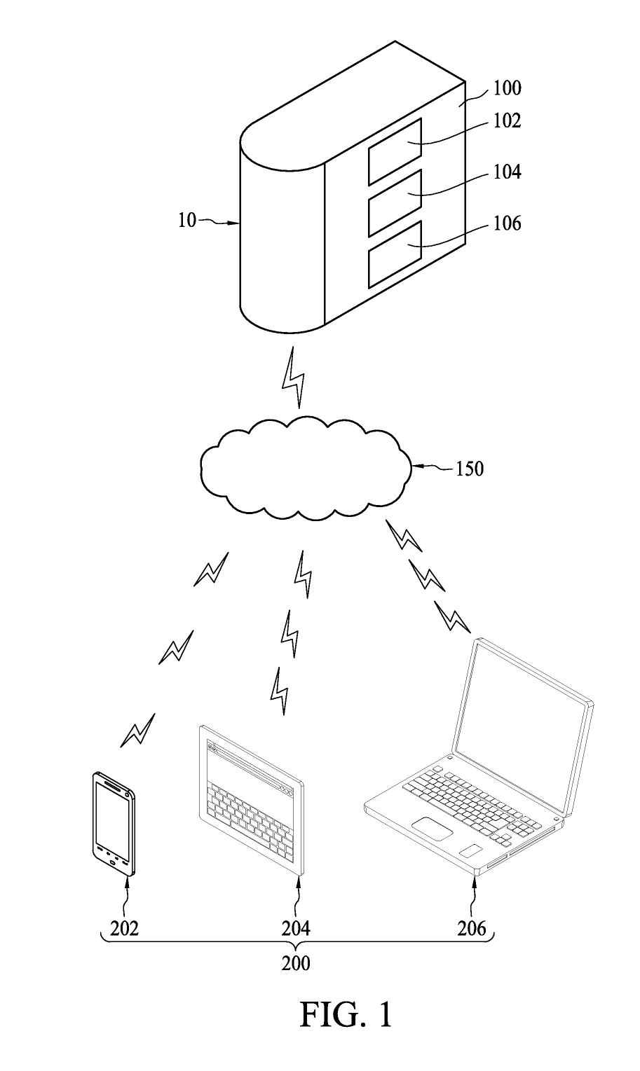

FIG. 1 is a schematic of a social networking system in accordance with some embodiments of the present disclosure.

Referring to FIG. 1, in some embodiments, a social networking system 10 is provided. The social networking system 10 includes an internet server 100 equipped with one or more processing units 102, a memory 104, and an I/O port 106. The processing unit 102, the memory 104, and the I/O port 106 are electrically connected with each other. Accordingly, electrical signals and instructions can be transmitted there-between. In addition, the I/O port 106 is configured as an interface between the internet server 100 and any external device. Therefore, electrical signals can be transmitted in and out of the internet server 100 via the I/O port 106.

In some embodiments in accordance with the present disclosure, the processing unit 102 is a central processing unit (CPU) or part of a computing module. The processing unit 102 is configured to execute one or more programs stored in the memory 104. Accordingly, the processing unit 102 is configured to enable the internet server 100 to perform specific operations disclosed herein. It is to be noted that the operations and techniques described herein may be implemented, at least in part, in hardware, software, firmware, or any combination thereof. For example, various aspects of the described embodiments may be implemented within one or more processing units, including one or more microprocessing units, digital signal processing units (DSPs), application specific integrated circuits (ASICs), field programmable gate arrays (FPGAs), or any other equivalent integrated or discrete logic circuitry, as well as any combinations of such components. The term “processing unit” or “processing circuitry” may generally refer to any of the foregoing logic circuitry, alone or in combination with other logic circuitry, or any other equivalent circuitry. A control unit including hardware may also perform one or more of the techniques of the present disclosure.

In some embodiments in accordance with the present disclosure, the memory 104 includes any computer readable medium, including, but not limited to, a random access memory (RAM), read only memory (ROM), programmable read only memory (PROM), erasable programmable read only memory (EPROM), electronically erasable programmable read only memory (EEPROM), flash memory, a hard disk, a solid state drive (SSD), a compact disc ROM (CD-ROM), a floppy disk, a cassette, magnetic media, optical media, or other computer readable media. In certain embodiments, the memory 104 is incorporated into the processing unit 102.

In some embodiments in accordance with the present disclosure, the internet server 100 is configured to utilize the I/O port 106 communicate with external devices via a network 150, such as a wireless network. In certain embodiments, the I/O port 106 is a network interface component, such as an Ethernet card, an optical transceiver, a radio frequency transceiver, or any other type of device that can send and receive data from the Internet. Examples of network interfaces may include Bluetooth®, 3G and WiFi® radios in mobile computing devices as well as USB. Examples of wireless networks may include WiFi®, Bluetooth®, and 3G. In some embodiments, the internet server 100 is configured to utilize the I/O port 106 to wirelessly communicate with a client device 200, such as a mobile phone 202, a tablet PC 204, a portable laptop 206 or any other computing device with internet connectivity. Accordingly, electrical signals are transmitted between the internet server 100 and the client device 200.

In some embodiments in accordance with the present disclosure, the internet server 100 is a virtual server capable of performing any function a regular server has. In certain embodiments, the internet server 100 is another client device of the social networking system 100. In other words, there may not be a centralized host for the social networking system, and the client devices 200 in the social networking system are configured to communicate with each other directly. In certain embodiments, such client devices communicate with each other on a peer-to-peer (P2P) basis.

In some embodiments in accordance with the present disclosure, the client device 200 may include one or more batteries or power sources, which may be rechargeable and provide power to the client device 200. One or more power sources may be a battery made from nickel-cadmium, lithium-ion, or any other suitable material. In certain embodiments, the one or more power sources may be rechargeable and/or the client device 200 can be powered via a power supply connection.

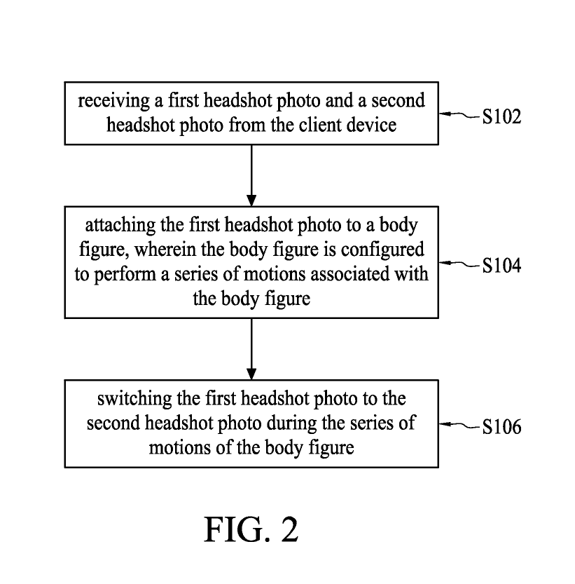

FIG. 2 is a flow chart of operations of the social networking system in accordance with some embodiments of the present disclosure.

Referring to FIG. 2, in operation S102, in some embodiments, the internet server 100 receives data from the client device 200. The data includes a first headshot photo and a second headshot photo. The first and second headshot photos may represent facial expressions of a user of the client device 200. In certain embodiments, the client device 200 includes an imaging module, which may be equipped with a CMOS or CCD based camera or other optical and/or mechanical designs. Accordingly, the user can take his/her own headshot photos instantly at the client device 200 and transmit such headshot photos to the internet server 100. In certain embodiments, the first and the second headshot photo include different facial expressions of the user. For example, the first headshot photo is a smiling face of the user, and the second user is a sad face of the user. Alternatively, the first and second headshot photos may be any photo representing different facial expressions of anyone. In some embodiments, such headshot photos may not represent a human face. For example, the headshot photos may represent a cartoon figure's or an animal's face, depending on the choice of the user of the client device 200.

In operation S104, in some embodiments, the processing unit 102 is configured to attach the first headshot photo to a body figure. In certain embodiments, the body figure is a human body figure having four limbs. Alternatively, the body figure may be an animal's body figure or any other body figure suitable for more accurately and vividly expressing emotions of the user of the client device 200. The body figure is configured to perform a series of motions associated with the body figure. For example, the body figure may be dancing. Furthermore, the costume of the body figure may be altered. In addition, the dancing moves of the body figure may be changing. Being attached to the dancing body figure, the first headshot photo is configured to move along and associate with the motion of the body figure, creating an animated body figure. In certain embodiments, a short clip of animation is generated.

In operation S106, in some embodiments, the processing unit 102 is configured to switch the first headshot photo with the second headshot photo during the series of motions of the body figure. In other words, the facial expression of the animated human figure is configured to change while the body figure is still in motion. For example, the headshot photo may be changed from the smiling face one to the sad face one during the dancing motion of the body figure. Accordingly, an emotion of the user of the client device 200, who uploaded the headshot photos to the internet server 100, is expressed through the face-changing animation. Moreover, due to the change or switch between the first and second headshot photos, the emotion of the user is expressed more accurately or vividly.

In some embodiments in accordance with the present disclosure, the internet server 100 is configured to record the series of motion of the body figure along with the change of the first headshot photo and the second headshot photo so as to generate an animation file. The animation file is then transmitted to the client device 200 to be displayed at the client device 200. In certain embodiments, the animation file is a short animation clip, which occupies more storage space. Such animation file can be played by any video player known to persons having ordinary skill in the art. For example, the animation file may be a YouTube compatible video format. In another example, the animation file may be played by the Windows Media Player, the Quicktime Player, or any flash player. In some embodiments, the animation file includes parameters of the body figure and the facial expression of the headshot photo, which occupies less storage space. Such parameters are sent to the client device 200, wherein a short animation clip is generated. Accordingly, network bandwidth and processing resources of the internet server 100 may be preserved. In addition, the user at the client device 200 will experience less delay when reviewing the animation file generated at the internet server 100. In some other embodiments, the animation file includes only specific requests to instruct the client device to display a specific series of motions of the body figure to be interchangeably attached with the first and second headshot photos. For example, the animation file includes a request to display a series of motions of the body figure with a predetermined number No. 163. In response, the client device 200 plays the series of motions of No. 163 and outputs such series of motions at its display. Specific timings during the series of motions or specific postures of the body figure for headshot photo switch may be predetermined in the series of motions of No. 163. Thus, a body figure performing a series of motions and having interchanging headshot photos is generated at the client device 200. As a result, different emotions of a user are expressed in a more accurate and vivid way though the interchanging headshot photos.

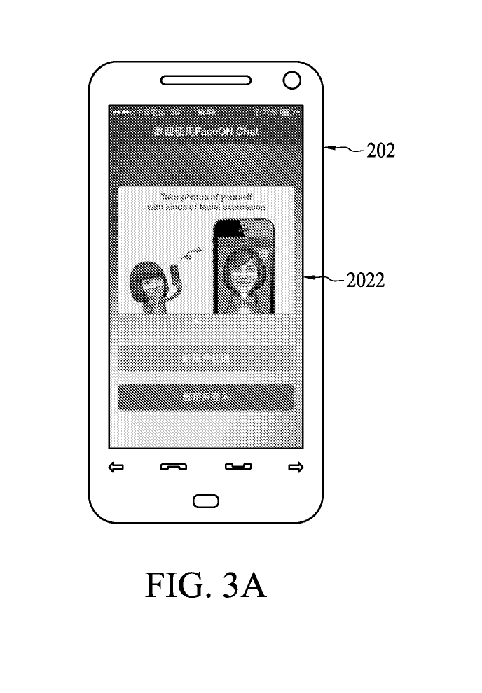

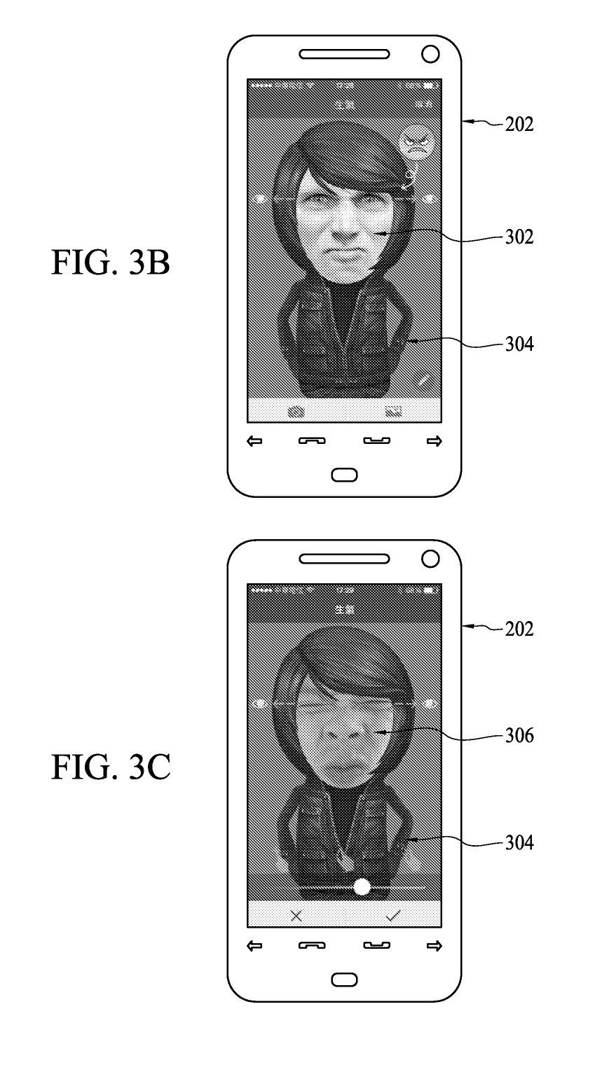

FIGS. 3A-3C illustrate GUI display at the social networking system in accordance with some embodiments of the present disclosure.

Referring to FIG. 3A, in some embodiments, the client device of the social networking system is a mobile phone 202. The mobile phone 202 includes an output device 2022 for displaying the animation file generated at the internet server 100. Examples of the output device 2022 includes a touch-sensitive screen, a cathode ray tube (CRT) monitor, a liquid crystal display (LCD), or any other type of device that can provide output to a user. In certain embodiments, a graphical user interface (GUI) of an application at the mobile phone 202 prompts the user to take headshot photos to be uploaded to the internet server 100. In some embodiments, the user is prompted to take headshot photos of different facial expressions. The different facial expressions represent different emotions of the user. In certain embodiments, the headshot photos are the facial expressions of a different user. Accordingly, emotions of such different user may be demonstrated. Alternatively, the headshot photos may be facial expressions not of a human. For example, a real-life bear or an animated bear.

Referring to FIG. 3B, in some embodiments, a first headshot photo 302 is taken at the mobile phone 202 to be uploaded to the internet server 100. Alternatively, the first head shot photo is cropped from a photo stored in the mobile phone 202. The first headshot photo 302 is attached to a body FIG. 304 provided by the internet server 100 or locally stored at the mobile phone 202 as the head of a human figure. The position of the first headshot photo 302 can be adjusted according to the posture of the body FIG. 304.

Referring to FIG. 3C, in some embodiments, a second headshot photo 306 is taken at the mobile phone 202 to be uploaded to the internet server 100. In certain embodiments, the first and the second headshot photos 302, 306 include different kinds of facial expressions. For example, the first headshot photo 302 demonstrates an angry face of the user of the mobile phone 202, and the second headshot photo 306 demonstrates a face expressing pain or sadness of the user of the mobile phone 202. Alternatively, the first and second head shot photos may be based on one original facial expression. The differences between such first and second headshot photos are the configuration of the facial features, such as eyes, nose, ear and mouth. For example, using a same smiling face as basis, the first headshot photo may have a facial expression of a faint smile with a first set of facial feature configuration, and the second headshot photo may have a facial expression of a big laughter with a second set of facial feature configuration. The different facial expressions are later used in conjunction with a series of motions of the body figure so as to provide more vivid and accurate emotional expressions to other users at other client devices of the social networking system 10.

In some embodiments in accordance with the present disclosure, more than two headshot photos are uploaded to the internet server 100 from the client device 200. For example, six headshot photos representing emotions of happy, angry, sad, joy, shocked and pain respectively are taken by the user and transmitted to the internet server 100. In addition, the memory 104 is stored with multiple body figures and their corresponding series of motions. Accordingly, multiple combinations of headshot photos, body figures and body motions are acquired. When animated, different emotions of a user are expressed though such combinations in a more accurate and vivid way.

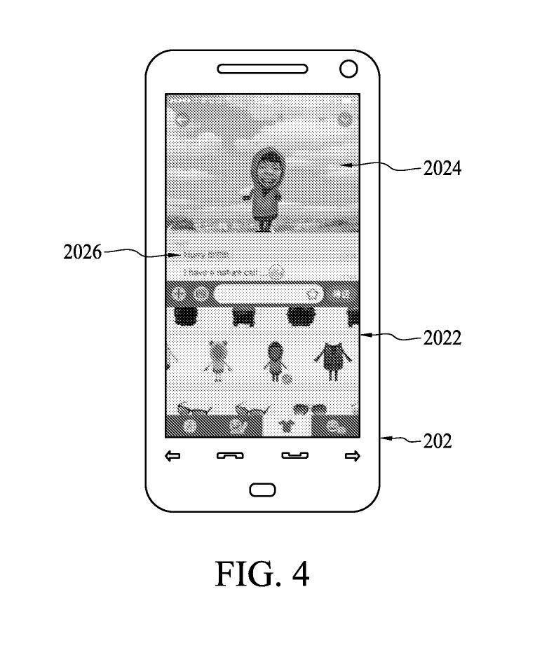

FIG. 4 illustrates GUI display at the social networking system in accordance with some embodiments of the present disclosure.

In some embodiments in accordance with the present disclosure, after receiving the headshot photos, the internet server 100 is configured to swap one headshot photo with another to the body figure during the series of motions of the body figure. Alternatively, the client device 200 serves the function to swap one headshot photo with another to the body figure during the series of motions of the body figure without cooperating with the internet server 100. For example, a first headshot photo is attached to the body figure at a first timing, and such first headshot photo is swapped by a second headshot photo at a second timing. In certain embodiments, headshot photos are swapped and attached to the body figure during the series of motions of the body figure. In some embodiments, at least four headshot photos are provided. The entire process of body figure motions and headshot photo swapping is recorded as an animation file. Such animation file is transmitted to one or more client devices from the internet server 100 or the client device 200 such that different users at different client devices can share the animation file and more comprehensively perceive the emotional expression of a specific user. Details of the animation file have been described in the previous paragraphs and will not be repeated.

Still referring to FIG. 4, in some embodiments, an instance of the animation file displayed at a mobile phone 202 is provided. The animation file is displayed within a frame 2024 at the output device 2022 of the mobile phone 202. At the present instance, a headshot photo having a smiling face is attached to the body figure in the running posture. In one of the following instances, a headshot photo having a sad face (not depicted) is attached to the body figure still in the running posture. Accordingly, a changing emotion of the user during the running process is presented. Specifically, another user may be able to perceive that the user has been running for such a long time that he feels tired already. Therefore, a more vivid expression of emotions is provided through the animation file. In addition, a series of change of emotions are also demonstrated through the animation file. More embodiments of change of headshot photos, i.e., facial expressions, at the body figure in motion will be presented in the following paragraphs.

In some embodiments in accordance with the present disclosure, the animation file includes texts 2026. The texts 2026 are entered by a user of the client device 200. In a two-client-device social networking system, the texts are entered by users at different client devices such that the users can communicate with each other along with the animation file. In certain embodiments, the texts are transmitted along with the animation file between the client devices 200 without the relay of an internet server.

In some embodiments in accordance with the present disclosure, the background of the frame 2024 is substitutable. The background may be substituted at different instances of the animation file, which may correspond to different postures of the body figure or different headshot photos. Specifically, one background may be substituted by another one corresponding to a change of one headshot photo to another. In certain embodiments, the background itself is an animation clip designed to correspond with the animation file. In some embodiments, a user may choose to use a photo as the background of the frame 2024 to more accurately demonstrate the scenario or story of the animation file.

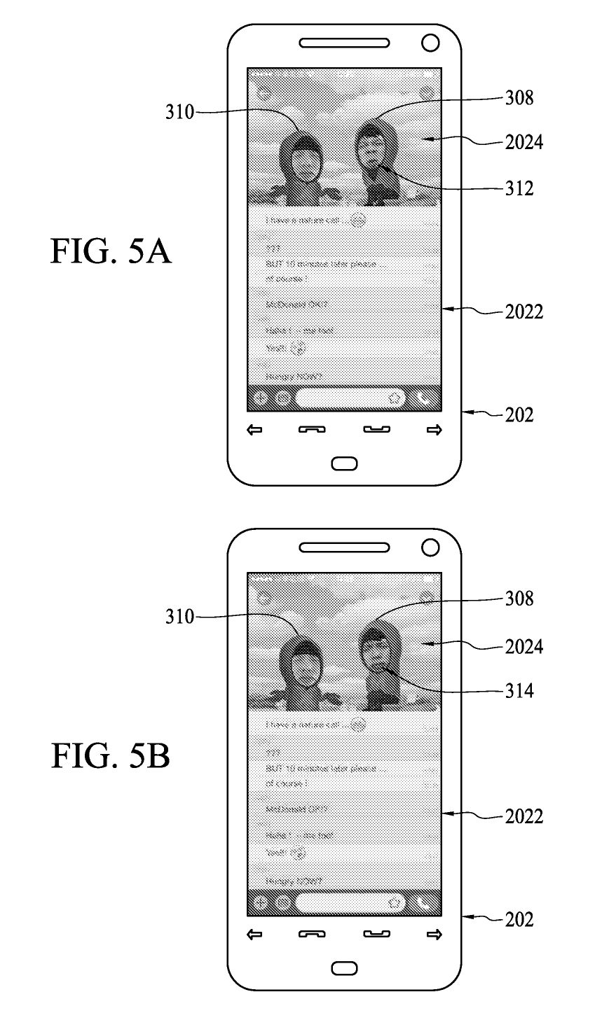

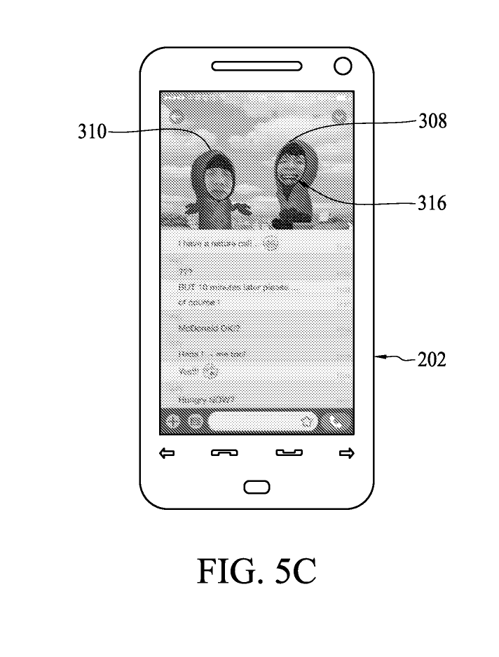

FIGS. 5A-5C illustrate GUI display at the social networking system in accordance with some embodiments of the present disclosure.

In some embodiments in accordance with the present disclosure, a headshot photo is switched to another one at one random moment during the series of motions of the body figure in the animation file. In certain embodiments, a headshot photo is switched to another headshot photo at a predetermined moment during the series of motions of the body figure in the animation file. In some embodiments, a headshot photo is switched to another headshot photo at a predetermined posture of the body figure during the series of motions in the animation file.

Referring to FIG. 5A, a first instance of the animation file displayed at the mobile phone 202 is provided. Referring to FIG. 5B, a second instance of the animation file displayed at the mobile phone 202 is provided. Referring to FIG. 5C, a third instance of the animation file displayed at the mobile phone 202 is provided. In FIGS. 5A-5C, different headshot photos are attached to the body FIG. 308, while another body FIG. 310 is also provided. The body FIGS. 308 and 310 represent users of different client devices. Accordingly, the social networking system 100 allows users at different client devices to communicate with each other.

Referring to FIGS. 5A-5C, in some embodiments, a first, a second and a third headshot photo 312, 314, 316 is attached to the body FIG. 308 at different instances. In other words, during the series of motions of the body figure, headshot photo attached to the body figure is swapped by another one. In certain embodiments, headshot photos are swapped to another one at predetermined moments during the series of motions of the body figure so as to express the emotion or the mood of the user representing the body figure. For example, at the first instance, the first headshot photo is an angry face. At the second instance, the second headshot photo is a sad face. At the third instance, the third headshot photo is a happy face. Associated with the posture of sitting on a toilet, FIGS. 5A-5C more vividly present a user having constipation problem at the first instance, and resolving the issue at the third instance. Alternatively, the headshot photos are swapped at different postures of the body figure, as also illustrated in FIGS. 5A-5C. For example, the first and second headshot photos 312, 314 represent an annoyed face, which is relevant with the squatting posture of the body FIG. 308. The third headshot photo 316, on the other hand, represents a happy face, which is relevant to a relaxed posture of the body FIG. 308. In certain embodiments, the headshot photos are swapped at random moments of during the series of motions of the body figure in the animation file so as to create unpredictable expressions of emotions or moods of a user.

In some embodiments in accordance with the present disclosure, the user of the client device 200 only uploads two headshot photos to the internet server 100 and only the two headshot photos are interchangingly attached to the body figure during the series of motions of the body figure.

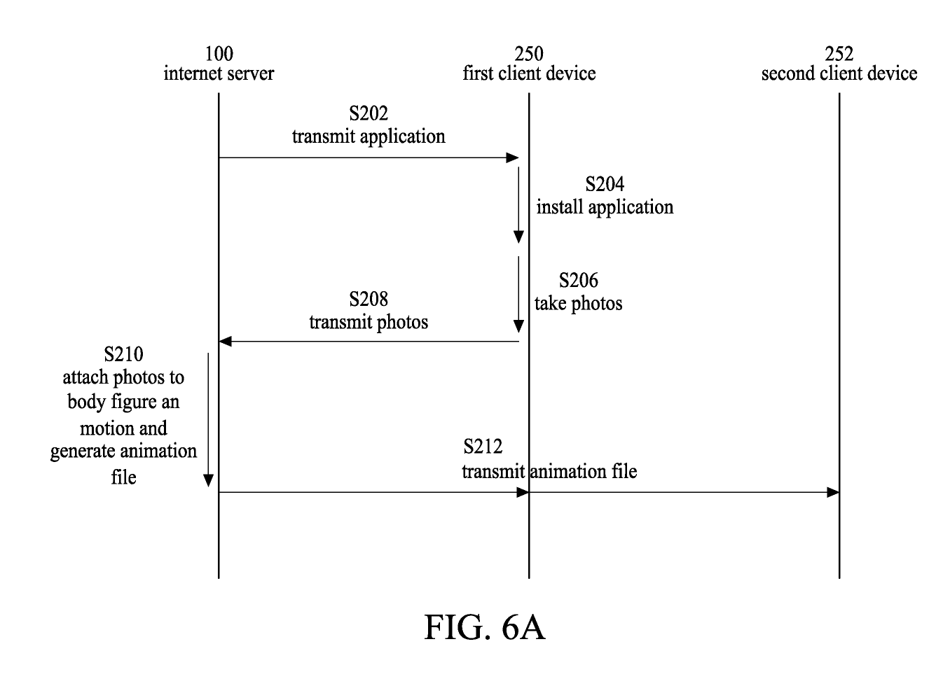

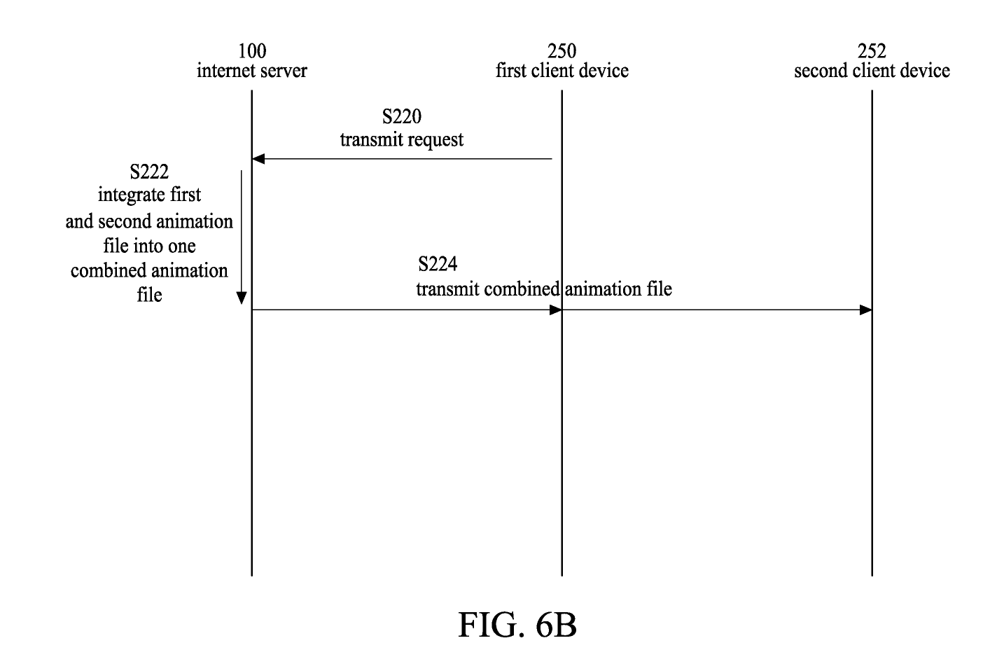

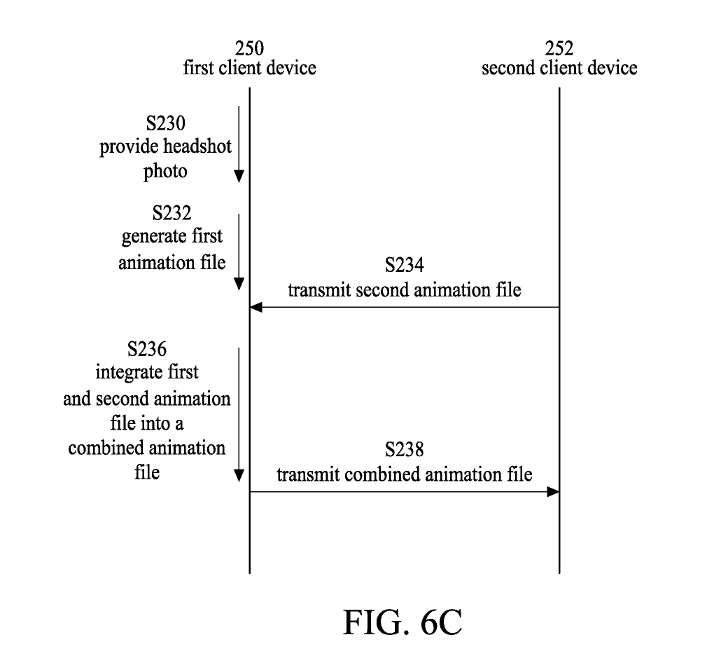

FIGS. 6A-6C illustrate interactions at the social networking system in accordance with some embodiments of the present disclosure.

Referring to FIG. 6A, in some embodiments in accordance with the present disclosure, a non-transitory, i.e., non-volatile, computer readable storage medium is provided. The non-transitory computer readable storage medium is stored with one or more programs. When the program is executed by the processing unit of a computing device (i.e. a server, a client device or any electronic device with processing power and Internet connectivity), the computing device is caused to conduct specific operations set forth below in accordance with some embodiments of the present disclosure. In some embodiments, examples of non-transitory storage computer readable storage medium may include magnetic hard discs, optical discs, floppy discs, flash memories, or forms of electrically programmable memories (EPROM) or electrically erasable and programmable (EEPROM) memories. In certain embodiments, the term “non-transitory” may indicate that the storage medium is not embodied in a carrier wave or a propagated signal. In some embodiments, a non-transitory storage medium may store data that can, over time, change (e.g., in RAM or cache).

In some embodiments in accordance with the present disclosure, in operation S202, a client application is transmitted to the first client device 250 upon a request of a user at the first client device 250. For example, the first client device 250 may be a smart phone downloading the application from the online application store. In operation S204, the application is installed at the first client device 250. Accordingly, specific functions may be executed by the user, such as taking photos, and sending and receiving animation files. In operation S206, headshot photos of the user is taken or stored into the storage of the first client device 250. At least two headshot photos are taken or stored. However, there is not maximum limit for the number of headshot photos.

In some embodiments in accordance with the present disclosure, in operation S208, the headshot photos are transmitted to the internet server 100 from the first client device 250. In operation S210, the internet server 100 is configured to attach one of the headshot photos to a body figure, which is performing a series of motions associated with such body figure. In certain embodiments, at least two headshot photos are received by the internet server 100. The at least two headshot photos are interchangingly attached to the body figure. Accordingly, a first animation file of the changing headshot photos along with the body figure in the series of motions is generated. Details of the animation file have been described in the previous paragraphs and will not be repeated. In some embodiments, an audio file may be integrated with the animation file so as to provide a different experience to any viewer of the animation file. The audio file may include any sound recording, such as a speech recorded by a user or a song. In operation S212, the first animation file is transmitted to the first client device 250. In some embodiments, the first animation file is also transmitted to the second client device 252. Accordingly, the user at the second client device 252 receiving the first animation file may more accurately and comprehensively perceive the emotion or mood of the user at the first client device 250 through the animation file.

In some embodiments in accordance with the present disclosure, operations S208 and S210 may be partially performed at the first client device 250. For example, the headshot photos may be attached to a body figure in motion at the first client device 250. In certain embodiments, the first animation file may be generated at the first client device 250 and then transmitted to the internet server 100 for additional operations.

In some embodiments in accordance with the present disclosure, the operations S202 through S208 are also executed at and between the internet server 100 and the second client device 252. Accordingly, a second animation file is generated either at the second client device 252 and sent to the internet server 100, or generated at the internet server 100. Thereafter, the second animation file is sent to the first client device 250 and the second client device 252 so as to enable communication between the users at each client device through the animation files. As a result, the emotions or moods of the users at each client device are more vividly expressed and perceived.

Referring to FIG. 6B, in some embodiments in accordance with the present disclosure, in operation S220, a request from the first client device 250 and/or the second client device 252 to interact with each other is transmitted to the internet server 100. In response to such request, the first and second animation files are transmitted to the first and second client devices 250, 252. Accordingly, an interaction between the users at each client device is created by the first and second animation files.

In some embodiments in accordance with the present disclosure, in operation S222, the internet server 100 is configured to combine the first and second animation files into a combined animation file. Accordingly, the body figures in the first and second animation files are configured to be physically interacting with each other. For example, the combined animation file may demonstrate that the first body figure may be strangling the second body figure. In operation S224, the combined animation file is transmitted to the first and second client devices 250, 252. Through the interchanging headshot photos at each body figure in the combined animation file, interactions between the users at each client device are more vividly expressed. Accordingly, emotions or moods of the users at each client device are more accurately and comprehensively perceived.

In some embodiments in accordance with the present disclosure, in one operation, a request from the first client device to interact with the second client device and a third client device is transmitted to the internet server 100. In response to such request, the first and second animation files are transmitted to the first, second and third client devices. In certain embodiments, the request received by the internet server 100 is that the users at the first, second and third client devices intend to interact with each other. Accordingly, animation files, i.e., first, second and third animation files, representing each user's emotion or mood is generated, either at each client devices or at the internet server 100. Thereafter, the first, second and third animation files are merged into one combined animation file such that all the body figures in the animation file are displayed in one frame. Such combined animation file is sent to the first, second and third client devices such that the users at each device may communicate with each other, and perceive the emotions of each user. Details of the third animation file are similar or identical to the first and/or second animation file, and will not be repeated.

In some embodiments in accordance with the present disclosure, the users at the first, second and third client devices are provided with an option to transmit feedback to the internet server 100. Depending on the intensity, e.g., total number, of the feedbacks, the internet server 100 is configured to change the combined animation file to an altered animation file. The altered animation file is then transmitted to all the client devices so each user may perceive the accumulated result of the feedbacks more accurately and comprehensively. For example, a voting invitation is transmitted to all the client devices through the internet server 100 from the first client device. All the users at the first, second and third client devices may have the option to place more than one vote in response to the voting invitation. If the internet server 100 receives a total number of the votes exceeding a predetermined threshold, the combined animation file will be altered. For example, the body figures representing each user might change from standing, in the combined animation file, to jumping, in the altered animation file. Accordingly, the combined emotion or mood of the group is expressed more vividly.

Referring to FIG. 6C, in some embodiments in accordance with the present disclosure, in operation S230, headshot photos are provided at the first client device 250. The headshot photo may be chosen from the memory of the first client device 250, or be taken by a camera of the first client device 250. Alternatively, the headshot photos are received from the second client device 252. The first and second client devices 250, 252 may be any computing device having processing power and internet connectivity. In operation S232, a first animation file including a body figure performing a series of motions and having interchanging headshot photos are generated. In operation S234, a second animation file is transmitted from the second client device 252. In certain embodiments, the transmission of the second animation file from the second client device 252 to the first client device 250 is conducted through a relay. In operation S236, a combined animation file is generated by integrating the first and second animation files. In operation S238, the combined animation file is transmitted to the second client device 252. Accordingly, the user at the second client device 252 can more accurately and comprehensively perceive the emotions of the user at the first client device 250 through the combined animation file. Further more, the combined animation file may be configured to tell a story through the integration of the first and second animation files. Therefore, any user watching the combined animation file will be able to more accurately and comprehensively perceive the emotions and the interactions between the users at the first and second client devices 250, 252.

In some embodiments in accordance with the present disclosure, an instruction to cause the second client device 252 to play the first or the combined animation file is transmitted from the first client device 250 to the second client device 252. Such instruction includes the first or the combined animation file and/or the parameters relevant with the first or the combined animation file. In certain embodiments, the instruction includes information representing the first or the combined animation file. In other words, the actual data of the first or the combined animation file may not be transmitted to the second client device 252. The instruction includes only the codes representing such first or combined animation file, and the first or the combined animation file actually being played is generated at the second client device 252. Accordingly, network bandwidth and processing resources of the social networking system may be preserved.

In some embodiments in accordance with the present disclosure, when the first and second animation file is integrated into the combined animation file, the facial expressions associated with the first body figure and the second body figure are further changed based on the interaction generated between the first and second animation files. In other words, when the first and second animation files in combination constitute a story or interaction between the users at different client devices, the facial expressions at each body figure are further changed to more vividly express the emotional interactions between such users. For example, the facial expressions at each body figure in the combined animation file may be enhanced or exaggerated to such that the viewers of the combined animation file can understand the story between the two body figures more accurately and vividly.

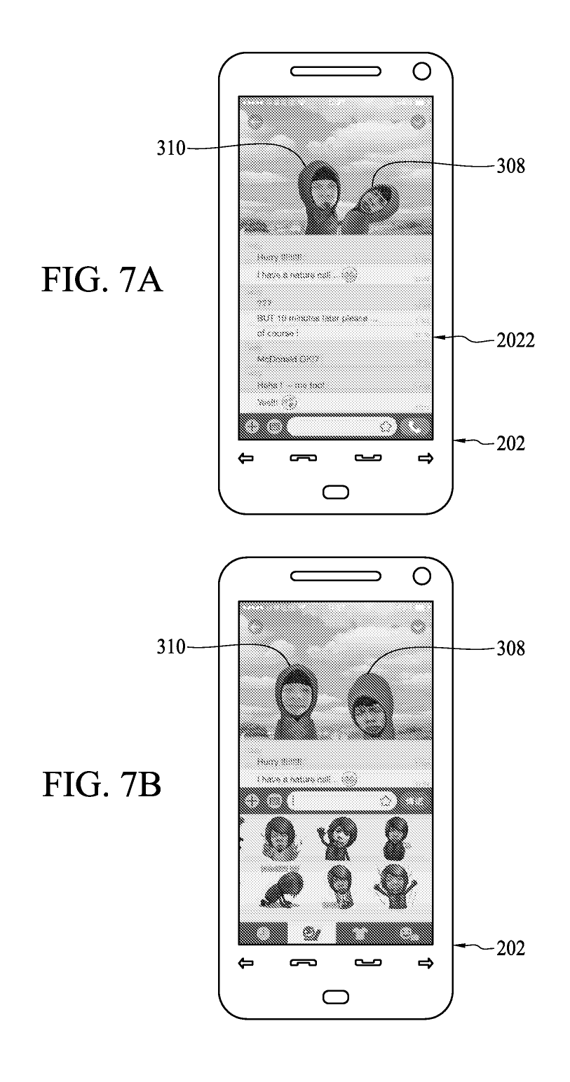

FIGS. 7A-7B illustrate GUI display at the social networking system in accordance with some embodiments of the present disclosure.

In FIG. 7A, with reference to operation S224 in FIG. 6B, in some embodiments in accordance with the present disclosure, a combined animation file is transmitted to the first and second client devices 250, 252 from the internet server 100. The combined animation file is displayed within a frame of an output device 2022 of a mobile phone 202. In response to the request of interaction between the first and second client devices 250, 252, the body FIGS. 308, 310 are configured to interact with each other. For example, at one instance of the combined animation file as illustrated in FIG. 7A, one body FIG. 310 is strangling the other body FIG. 308. Each body figure possesses its own headshot photos, i.e., facial expressions. For example, at the same instance as illustrated in FIG. 7A, a headshot photo of an angry face is attached to one body FIG. 310 and a headshot photo of a sad face is attached to the other body FIG. 308.

In FIG. 7B, in some embodiments in accordance with the present disclosure, at another instance of the combined animation file, the posture and the facial expressions of the body FIGS. 308, 310 are changed. For example, at such another instance of the combined animation file, one body FIG. 310 is standing and the other body FIG. 308 is leaning forward. Similarly, each body figure possesses its own headshot photos, i.e., facial expressions at such another instance of the combined animation file. For example, as illustrated in FIG. 7B, a headshot photo of a smiling face is attached to one body FIG. 310 and a headshot photo of a sad face is attached to the other body FIG. 308. Referring to FIGS. 7A-7B, in certain embodiments, the series of motions along with the change of facial expressions of the body figures, which is combined into one animation file, more vividly convey the emotion or mood of the users at each client device intend to express. In some embodiments, the series of motions and the change of facial expressions of the body figures are repetitive so as to allow users at client devices to better perceive the emotion or mood expression in a repeated manner.

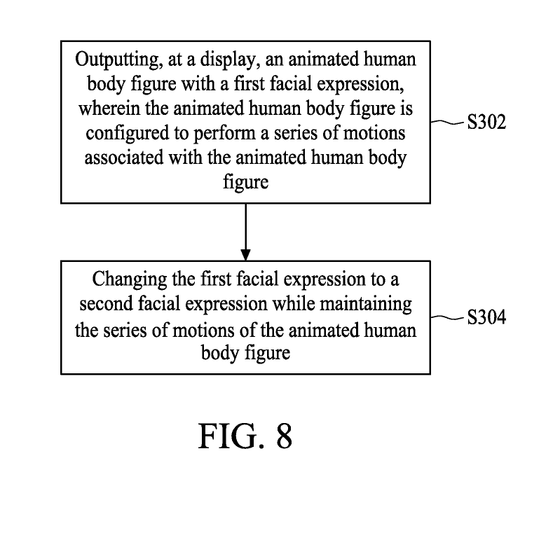

FIG. 8 illustrates a method for modeling emotions in animation in accordance with some embodiments of the present disclosure.

Referring to FIG. 8, in operation S302, a body figure with a first facial expression is displayed. The body figure is configured to perform a series of motions. For example, the body figure may be jumping, walking, or dancing in all kinds of styles. In operation S304, the facial expression is changed to a second facial expression while the series of motions of the body figure is maintained. Accordingly, through the changes in the combinations of body motions and facial expressions, emotions are more vividly and accurately modeled at the animated human figure.

In some embodiments in accordance with the present disclosure, the first and second facial expressions are interchanged according to some rules. For example, the facial expressions are interchanged at a predetermined moment during the series of motions. As the series of motions may be repetitive, the facial expression interchange may also be repetitive. In certain embodiments, the facial expressions are interchanged at random moments during the series of motions. Accordingly, unpredictable expression of emotions or moods through the body figure and the facial expressions may be generated. In some embodiments, the facial expressions are interchanged at a predetermined posture of the body figure during the series of motions. Accordingly, specific style or degree of emotion or mood may be presented through the specific combination of body motions and facial expressions.

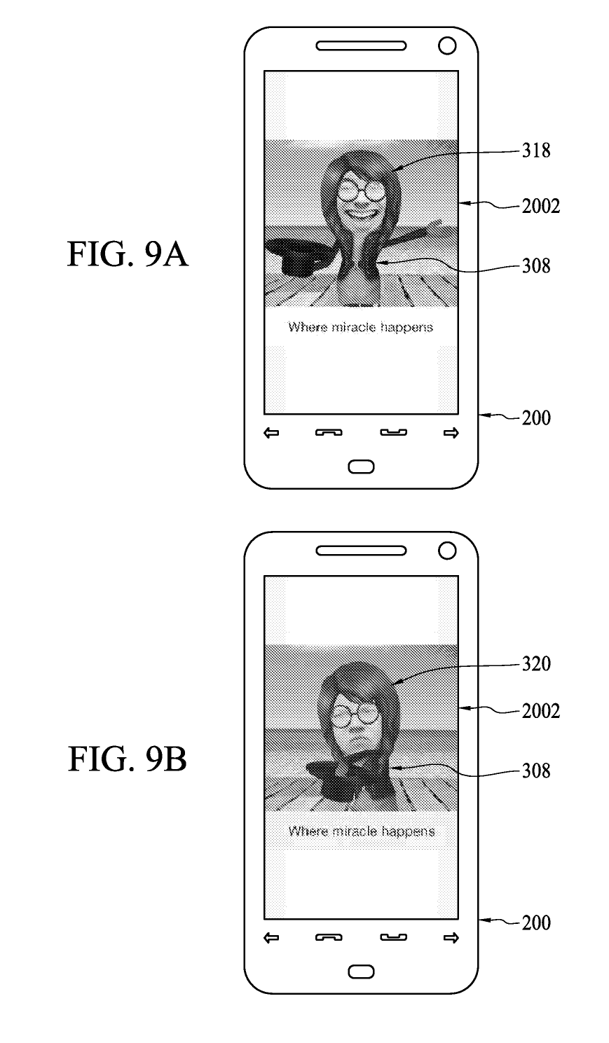

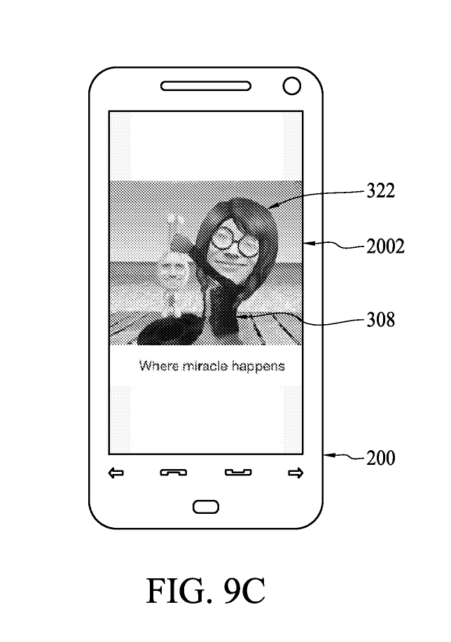

FIGS. 9A-9C illustrate GUI display at the social networking system in accordance with some embodiments of the present disclosure.

Referring to FIG. 9A, in some embodiments, a computing device or a client device 200 is provided. The computing device or a client device 200 includes an output device 2002 for displaying content such as a photo, a video or an animation. Details of the output device 2002 are similar with the output device 2022 and will not be repeated.

In some embodiments in accordance with the present disclosure, a body FIG. 308 is displayed at the output device 2002. In addition, a first headshot photo 318 having a first facial expression attached to the body FIG. 308 is displayed at the output device 2002. The body FIG. 308 is configured to perform a series of motions whereas each motion is linked and generated by a series of body postures. As explained in the method for modeling emotions in animation in accordance with some embodiments of the present disclosure in FIG. 8, different headshot photos are configured to be attached to the body FIG. 308 at different moments during the series of body motions or when the body FIG. 308 is at a specific posture.

In some embodiments in accordance with the present disclosure, in FIG. 9A, the body FIG. 308 in the animation file displayed is imitating a magician preparing to perform a magic show. In FIG. 9B, in some embodiments, the magician reaches his hand into his hat. At certain moments between the snapshots of the animation file as illustrated in FIGS. 9A and 9B, the first headshot photo 318 is replaced by a second head shot photo 320, which has a different facial expression from the first headshot photo 318. The switch of the headshot photos may be corresponding to some specific moments during the series of body motions, some specific acts that the body FIG. 308 is performing, or some specific postures that the body FIG. 308 is in. In FIG. 9C, in some embodiments, the magician is finalizing his magic show. When a rabbit is pulled out of the hat, the second head shot photo 320 is replaced by a third headshot photo 322, which has a different facial expression from the second headshot photo 320. In certain embodiments, the second headshot photo 320 may be presenting a puzzled facial expression and the third headshot photo 322 may be presenting a happy facial expression. The switch of headshot photos or facial expressions along with the body motions in the animation file may present a closer resemblance of a real-time, in-person performance of the magician. Consequently, through the changes of headshot photos or facial expressions during the series of motions of the body FIG. 308, the animation file generated may deliver a person's feelings, emotions, moods or ideas in a more vivid or comprehensible way.

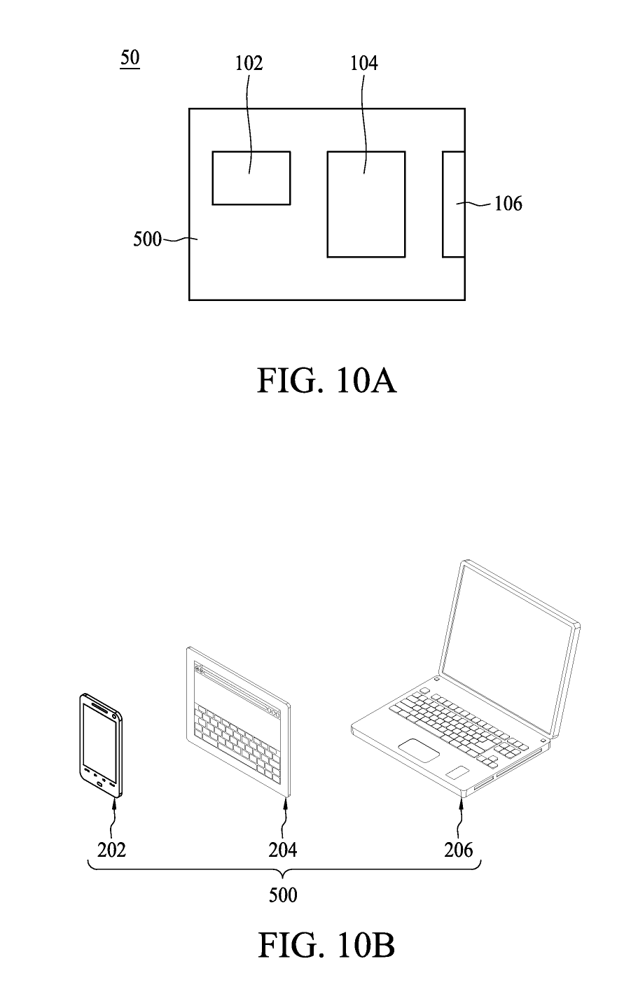

FIGS. 10A-10B are schematic views of a system for generating animated content in accordance with some embodiments of the present disclosure.

Referring to FIG. 10A, in some embodiments, a system 50 for generating animated content is provided. The system 50 includes a computing device 500 equipped with one or more processing units 102, a memory 104, and an I/O port 106. The processing unit 102, the memory 104, and the I/O port 106 are electrically connected with each other. Accordingly, electrical signals and instructions can be transmitted there-between. Details of the one or more processing units 102, the memory 104, and the I/O port 106 have been discussed in the previous paragraphs and therefore will not be repeated.

In some embodiments in accordance with the present disclosure, the computing device 500 is any electronic device with processing power. In certain embodiments, the computing device 500 is any electronic device having Internet connectivity. Referring to FIG. 10B, examples of the computing device 500 include mobile phones 202, tablet PCs 204, laptops 206, personal computers (not depicted) and any consumer electronic devices having a display and a processing unit.

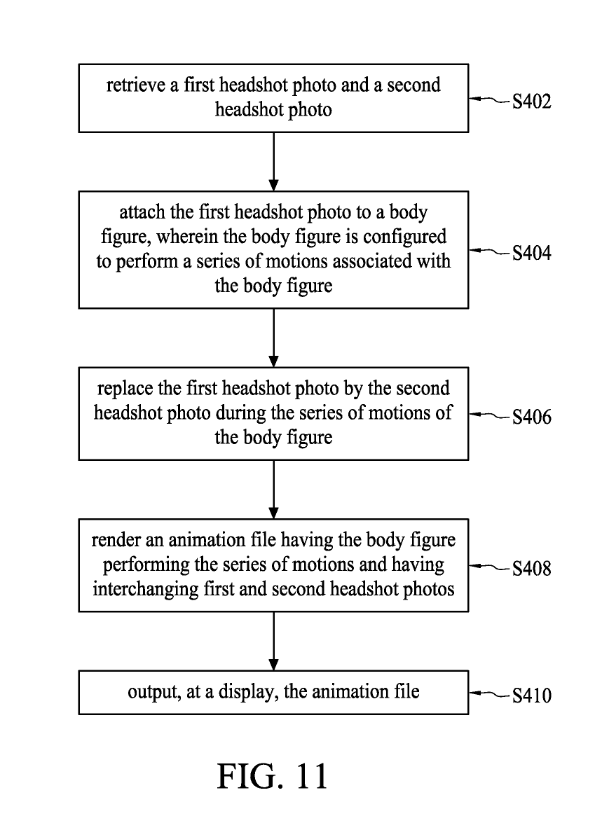

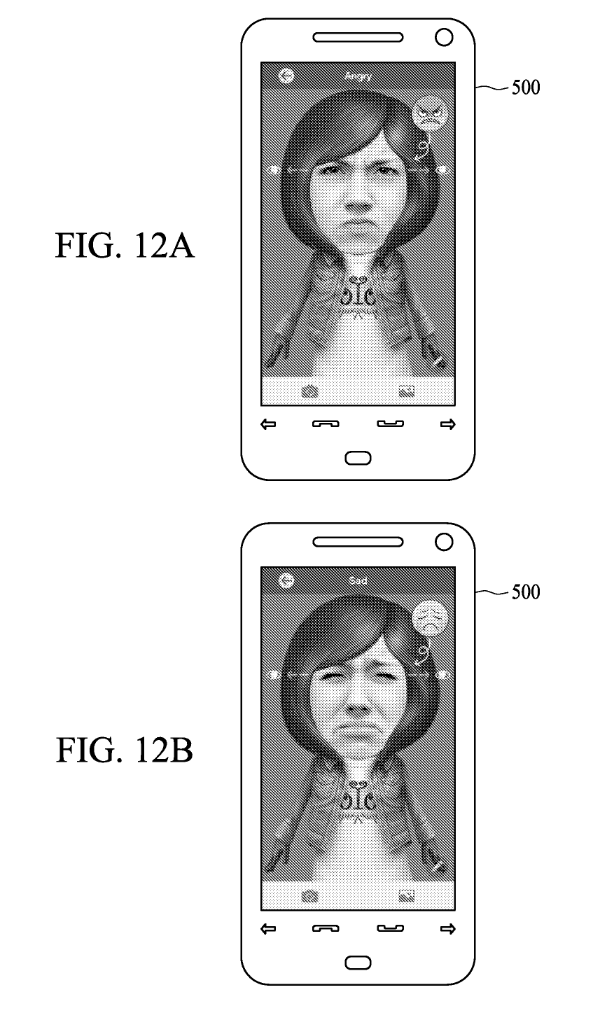

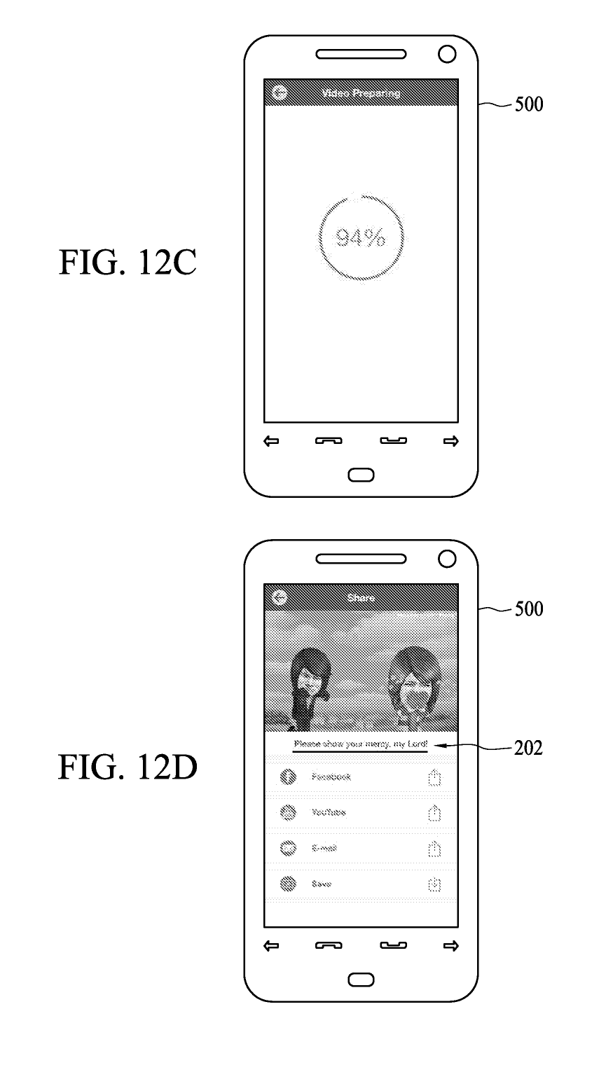

FIG. 11 is a flow chart of operations of the system for generating animated content in accordance with some embodiments of the present disclosure. FIGS. 12A-12D illustrate GUI display at the system for generating animated content in accordance with some embodiments of the present disclosure. In the following embodiments, references are made to FIG. 11 and FIGS. 12A-12D conjunctively to more clearly demonstrate the present disclosure.

In some embodiments in accordance with the present disclosure, one or more instructions are stored in the memory 104. Such one or more instructions, when executed by the one or more processing units 102, cause the system 50 or the computing device 500 to perform the operations set forth in FIG. 11.

Referring to FIG. 11, in operation S402, in some embodiments, a first headshot photo and a second headshot photo is retrieved at the computing device 500. The first and second headshot photos may be retrieved through several ways. In certain embodiments, the first and second headshot photos are acquired and cropped from photos already stored in the memory 104. In some embodiments, the first and second headshot photos are taken by an imaging module of the computing device 500. In certain embodiments, the first and the second headshot photo include different facial expressions of a human, for example, an angry face as illustrated in FIG. 12A, and a sad face as illustrated in FIG. 12B. Alternatively, the first and second headshot photos may be any photo representing different facial expressions of anyone. In some embodiments, such headshot photos may not represent a human face. For example, the headshot photos may represent a cartoon figure's or an animal's face, depending on the choice of the user of the computing device 500.

In operation S404, in some embodiments, the processing unit 102 is configured to attach the first headshot photo to a body figure. In certain embodiments, the body figure is a human body figure having four limbs. Alternatively, the body figure may be an animal's body figure or any other body figure suitable for more accurately and vividly expressing emotions of the user of the client device 200. The body figure is configured to perform a series of motions associated with the body figure.

In operation S406, in some embodiments, the processing unit 102 is configured to replace the first headshot photo by the second headshot photo during the series of motions of the body figure. In other words, the facial expression of the animated human figure is configured to change while the body figure is still in motion. For example, the headshot photo may be changed from the smiling face one to the sad face one during the dancing motion of the body figure. Furthermore, the background in which the body figure is configured to perform the series of motions may also be changed. In certain embodiments, the background is changed in response to the replacement of the first headshot photo by the second headshot photo. Accordingly, an emotion of the user of the computing device 500 is expressed through the face-changing animation. Moreover, due to the change or switch between the first and second headshot photos, the emotion of the user is expressed more accurately or vividly.

In operation S408, in some embodiments, an animation file is rendered by the processing unit 102, as illustrated in FIG. 12C. The animation file includes the body figure performing the series of motions and having interchanging first and second headshot photos. Accordingly, an animation file capable of being performed or played by any commercial video player is generated by the user of the computing device 500, and such animation file contains animated content which may demonstrate emotions of the user more accurately or more vividly. In certain embodiments, the animation file is in any format compatible to ordinary video player known to the public. Such formats may include MP4, AVI, MPEG, FLV, MOV, WMV, 3GP, SWF, MPG, VOB, WF, DIVX, MPE, M1V, M2V, mpeg4, ASF MOV, FLI, FLC, RMVB, and so on. Animation file of other video formats are within the contemplated scope of the present disclosure. Consequently, through the system disclosed in the present disclosure, an individual may create an animation file or a video having his personal traits in an easier way.

In operation S410, in some embodiments, the animation file is outputted at a display of the computing device 500, as illustrated in FIG. 12D. Examples of the display includes a touch-sensitive screen, a cathode ray tube (CRT) monitor, a liquid crystal display (LCD), or any other type of device that can provide output to a user. Through the display, the emotions of the user of the computing device 500 may be expressed in a more accurate or more vivid way. In certain embodiments, the user may choose to transmit the animation file to other computing devices having displays for outputting such animation file. Consequently, other users at different computing devices may better perceive the emotions of the user of the computing device 500 more accurately or more vividly. Referring to FIG. 12D, there are several additional operations for the user to pick. For example, the user may choose to upload the animation file to a social networking website, such as facebook, so as to share the animation file with his or her friends. The user may also choose to save the animation file for future use.

Referring to FIG. 12D, in some embodiments, a text 510 is incorporated into the animation file. Through the combination if the text 510 and the animation file, emotions of the user of the computing device 500 or any user who generated the animation file, may be demonstrated in a more accurate or more vivid way.

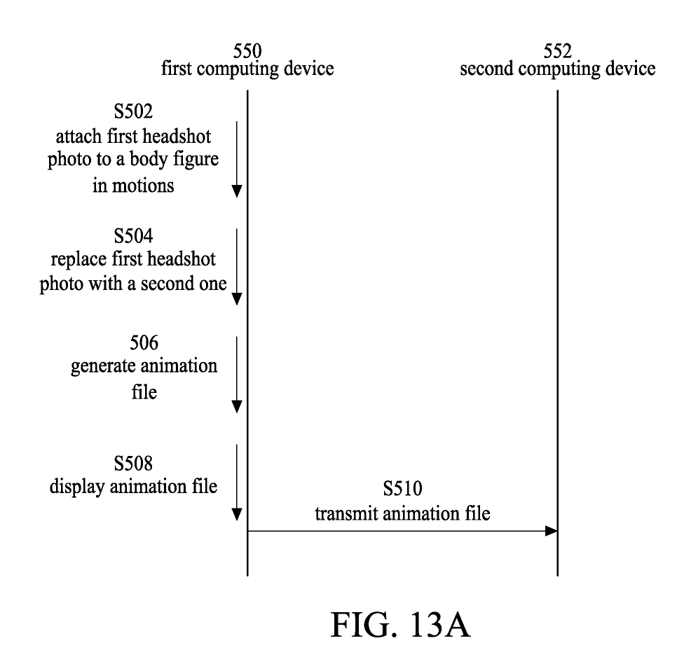

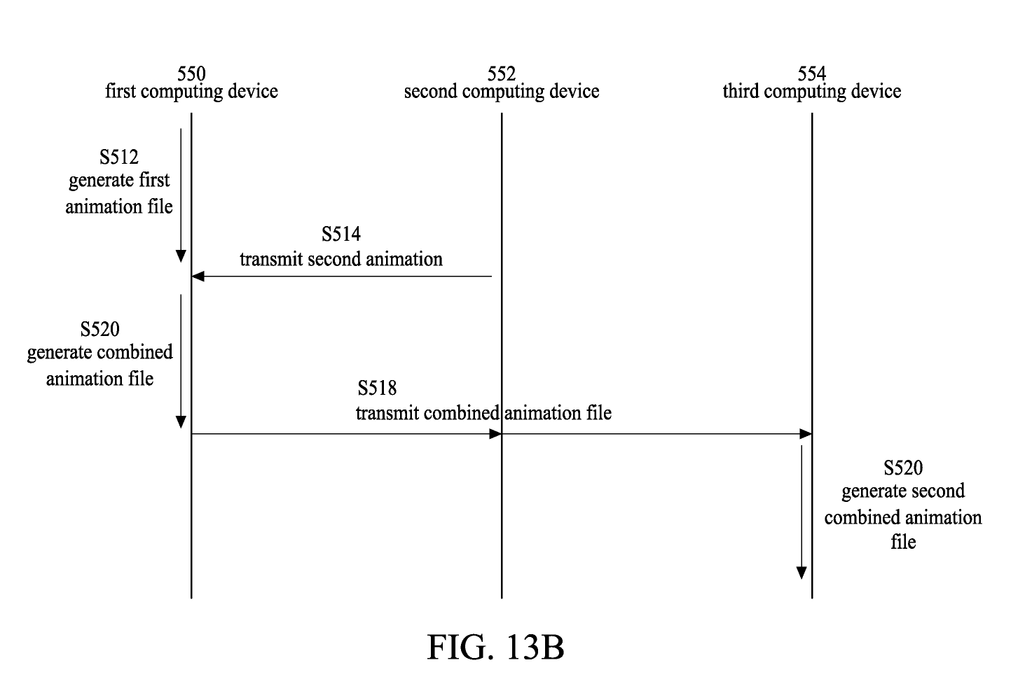

FIGS. 13A-13B illustrate interactions of the method for generating animated content at a system in accordance with some embodiments of the present disclosure.

Referring to FIG. 13A, in some embodiments in accordance with the present disclosure, a non-transitory, i.e., non-volatile, computer readable storage medium is provided. The non-transitory computer readable storage medium is stored with one or more programs. When the program is executed by the processing unit of a computing device 550, 552, the computing device 550, 552 is caused to conduct specific operations set forth below in accordance with some embodiments of the present disclosure. In some embodiments, examples of non-transitory storage computer readable storage medium may include magnetic hard discs, optical discs, floppy discs, flash memories, or forms of electrically programmable memories (EPROM) or electrically erasable and programmable (EEPROM) memories. In certain embodiments, the term “non-transitory” may indicate that the storage medium is not embodied in a carrier wave or a propagated signal. In some embodiments, a non-transitory storage medium may store data that can, over time, change (e.g., in RAM or cache).

In some embodiments in accordance with the present disclosure, in operation S502, a first headshot photo is attached to a body figure, and the body figure is configured to perform a series of motions. In response to the series motions of the body, the facial features of the first headshot photo may be changed.

In some embodiments in accordance with the present disclosure, in operation S504, the first headshot photo is replaced by a second headshot photo while the series of motions of the body figure are maintained to be performed. In certain embodiments, there are more than two headshot photos, for example, four headshot photos, being interchangingly attached to the body figure. In some embodiments in accordance with the present disclosure, a headshot photo is switched to another one at one random moment during the series of motions of the body figure in the animation file. In certain embodiments, a headshot photo is switched to another headshot photo at a predetermined moment during the series of motions of the body figure in the animation file. In some embodiments, a headshot photo is switched to another headshot photo at a predetermined posture of the body figure during the series of motions in the animation file.

In some embodiments in accordance with the present disclosure, in operation S506, an animation file is generated. The animation file includes the body figure performing the series of motions and attached with one of the first and second headshot photos. Through the interchanging headshot photos accompanied with the series of body motions, a user's emotions may be expressed in a more accurate or more vivid way. In addition, any user would be able to generate an animation file having his personal traits or expressing his personal feelings more vividly in an easier way.

In some embodiments in accordance with the present disclosure, in operation S508, the animation file is displayed at the first computing device 550. Anyone watching the animation file at the first computing device 550 will now be able to more accurately and comprehensively perceive the emotions that the user of the first computing device 550 is trying to express.

In some embodiments in accordance with the present disclosure, in operation S510, the animation file is transmitted to the second computing device 552. In other words, the animation file is shared with another user at the second computing device 552 by the user at the first computing device 550. The animation file is in a video format compatible to compatible to ordinary video player known to the public. In certain embodiments, the transmission includes an instruction to cause the second computing device 552 to display the animation file. In some embodiments, after receiving the animation file, the second computing device 552 is configured to integrate the animation file with another animation file at the second computing device 552 into a combined animation file. In certain embodiments, the combined animation file includes interactions between the body figures in the animation files integrated. During such interactions, the facial features of the headshot photos at each body figure may be further altered to more vividly reflect such interaction. In some embodiments, the combined animation is intended to tell a story. For example, the one animation file may demonstrate that a baseball batter is hitting a ball, and the other animation file may demonstrate that an outfielder caught a ball. When separately displayed, each of the two animation files may only demonstrate one single event. However, when linked into a combined animation file, a story of “a hitter's high fly ball is caught by a beautiful play of the outfielder” may be demonstrated. Therefore, according to the present disclosure, users may now generate animation files conveying more vivid or comprehensible stories or feelings in an easier way.

Referring to FIG. 13B, in some embodiments in accordance with the present disclosure, in operation S512, a first animation file including a first body figure having interchanging headshot photos and performing a series of motions associated with the first body figure is generated at the first computing device 550.

In some embodiments in accordance with the present disclosure, in operation S514, a second animation file is transmitted from the second computing device 552 to the first computing device 550. Similar to the first animation file, the second animation file includes a second body figure having interchanging headshot photos and performing a second series of motions associated with the second body figure.

In some embodiments in accordance with the present disclosure, in operation S516, the first and second animation files are integrated into a combined animation file. As disclosed in the previous paragraphs, the combined animation file may demonstrate an interaction between the first and second body figures, or their emotions, in a more vivid and comprehensive way.

In some embodiments in accordance with the present disclosure, in operation S518, the combined animation file is transmitted to a third computing device 554. Alternatively, the combined animation file may be transmitted to as many computing devices as the user at the first client device desires. In certain embodiments, the transmission of the combined animation file to a third party needs an approval from all the parties involved in the contribution to the combined animation file. For example, the user at the second computing device 552 may choose to block the transmission of any animation file relevant to such user to the third computing device 554. Accordingly, an attempt to transmit the combined animation file from the first computing device 550 to the third computing device 554 will not be allowed.

In some embodiments in accordance with the present disclosure, in operation S520, after receiving the combined animation file, the third computing device 554 is configured to generate a second combined animation file by integrating the combined animation file with a third animation file. By adding the third animation file, the emotions expressed in the original combined animation file may be further enhanced. Alternatively, the stories demonstrated in the original combined animation file may be continued and extended. Thereafter, the second combined animation file may be transmitted to yet other computing devices such that such animation file may be used and extended by other users. In some embodiments, a short clip of animated video may be created and shared between friends in an easier way. In addition, derivative works of such animated video may also be created in an easier way.

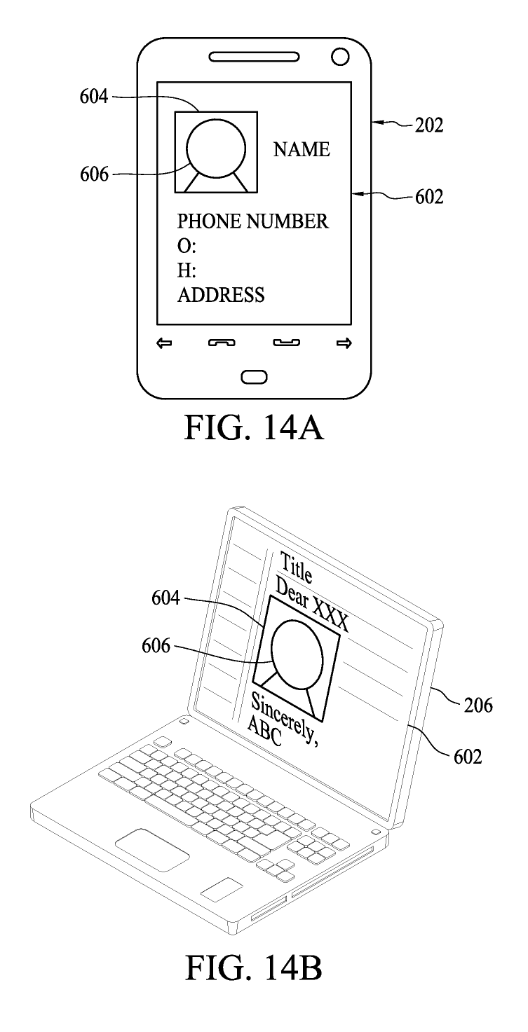

FIGS. 14A-14B illustrate the GUI display at a system for generating an animated content in accordance with some embodiments of the present disclosure.

In some embodiments in accordance with the present disclosure, with reference to FIG. 10B, the system for generating an animated content includes one of a mobile phone 202, a portable laptop 206 and any other computing device with processing power and/or internet connectivity. Referring to FIG. 14A, the mobile phone 202 includes a display 602, at which contents are displayed. The contents may include any information or document stored at or received by the mobile phone 202. In some embodiments, the content displayed is the contact information in a phone book. The contact information generally includes name, phone number, address, email and other relevant information of such contact. In still some embodiments, the contact information displayed includes a photo 606 such that the user may discern who the contact person is more easily. For example, the photo 606 of the contact person is displayed within a frame 604.

Referring to FIG. 14B, another exemplary system for generating an animated content is provided. In some embodiments, the system is a portable laptop 206. Similarly, the portable laptop 206 includes a display 602 for displaying contents. For example, the display 602 is displaying the interface of an email system and, more specifically, is displaying the contact person of the email system. In still some embodiments, photo 606 is displayed in a frame 604 such that the user may discern who the contact person is more easily.

In some embodiments in accordance with the present disclosure, the photo 606 in displayed in the frame 604 is a headshot photo, which shows the head and a limited part of the torso of a contact person are displayed in the frame. The headshot photo may be a photo of the user himself/herself, a person to be contacted by the user, a cartoon figure, or an animal face. In certain embodiments, a facial expression of the headshot photo 606 may be changed such that an emotion may be expressed more accurately or vividly. For example, the headshot photo 606 may be substituted with an animated content, i.e., animation or clip, of the contact person winking his/her eyes or having running nose. Through the altered facial expression of the headshot photo, the emotion or status of such contact person may be expressed more accurately or vividly.

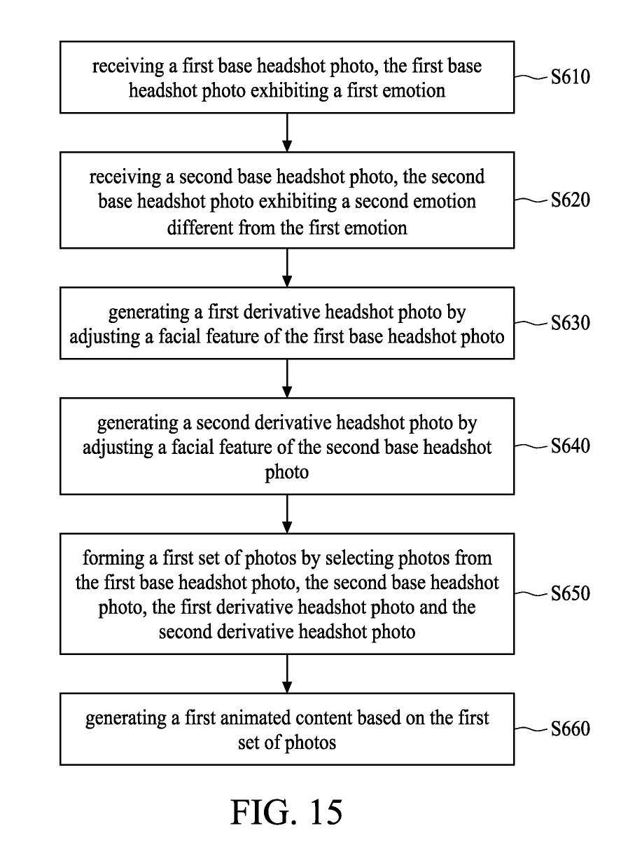

In some existing approaches, a headshot photo exhibiting an emotion, such as delight, anger or grief, is adjusted in order to show another emotion of a user. However, since emotions are basically significantly different from one another, such approaches may often end up in an adjusted headshot photo that exhibits a far-fetched, distorted emotion, not a desired one the user would expect it to be. To more actually express the change of emotion, a method illustrated in FIG. 15 according to the present disclosure is provided.

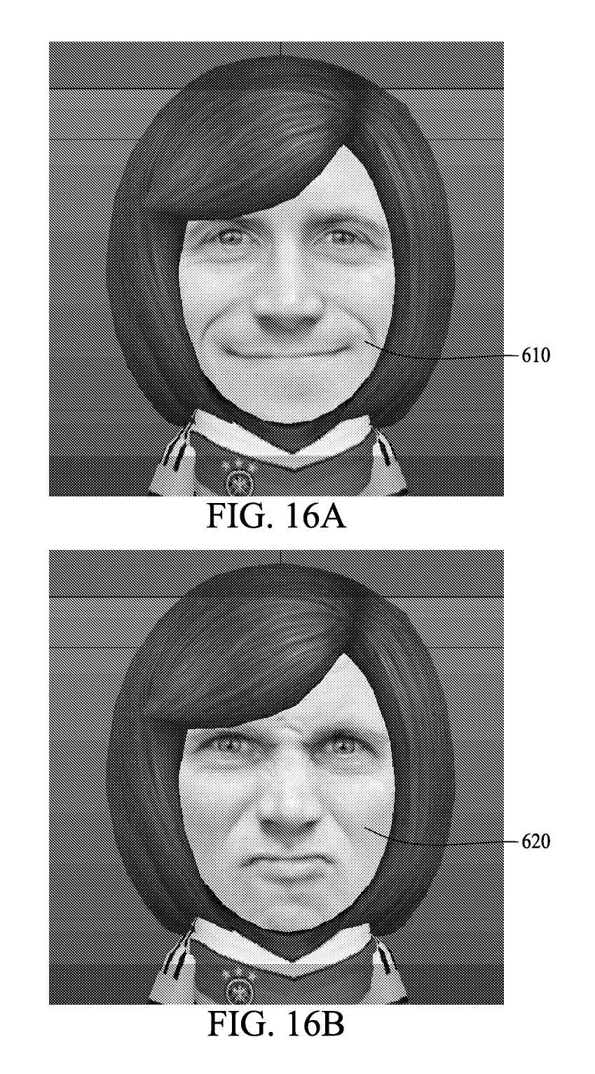

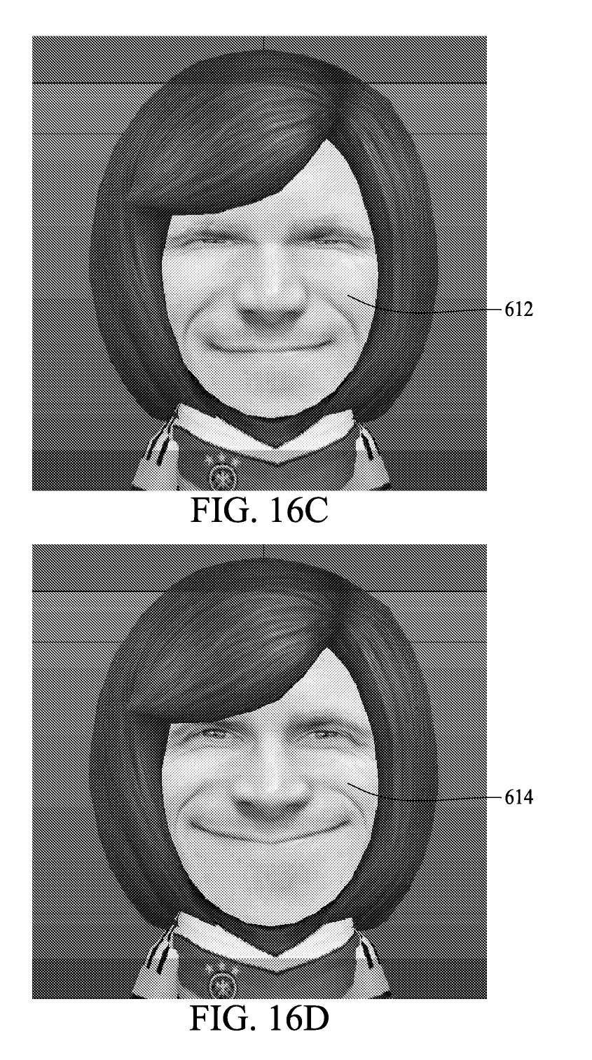

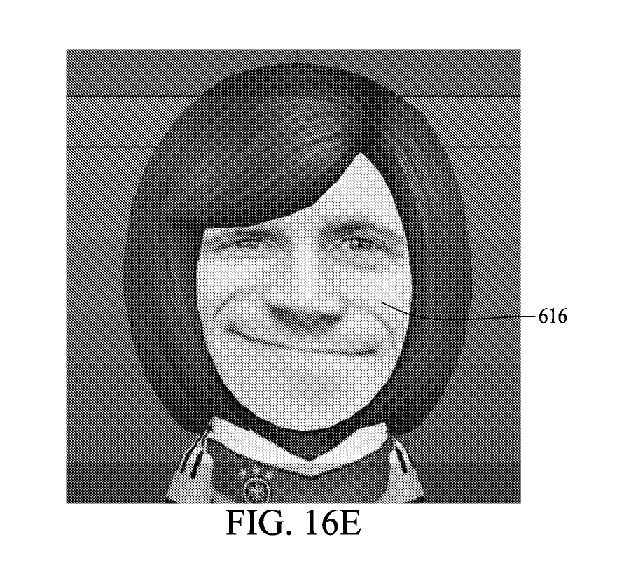

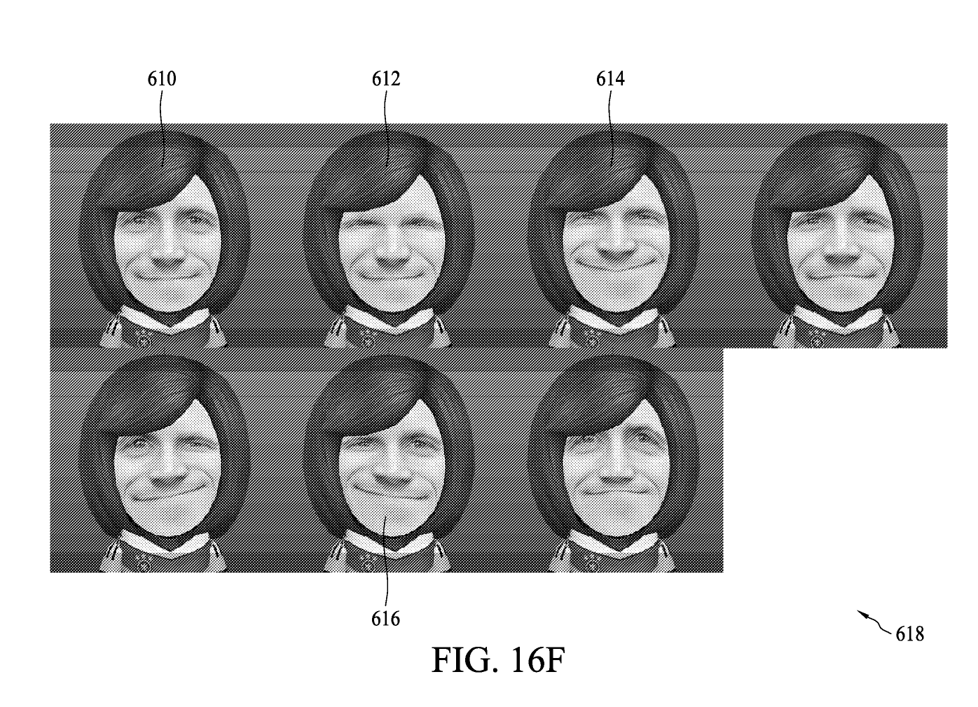

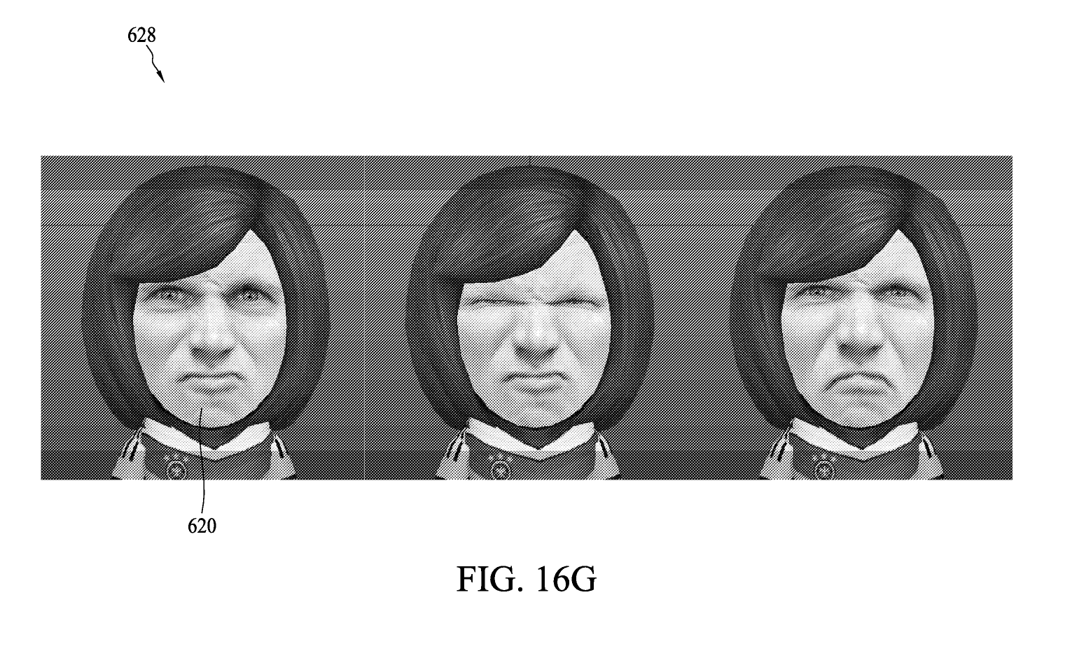

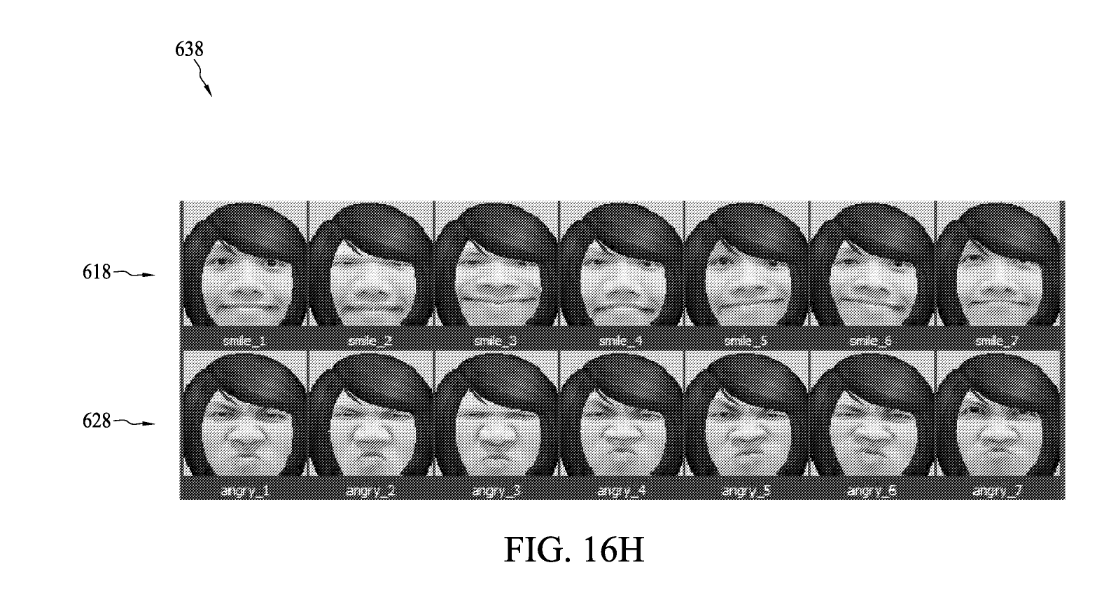

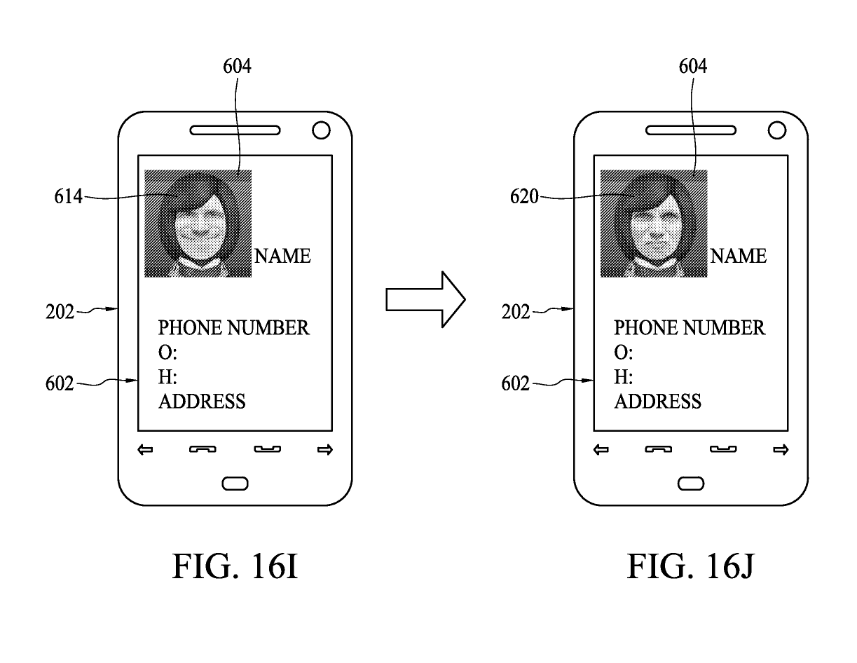

FIG. 15 is a flow chart of operations of the system for generating an animated content in accordance with some embodiments of the present disclosure. FIGS. 16A-16J illustrate a method for generating an animated content in the system in accordance with some embodiments of the present disclosure. In the following embodiments, references are made to FIG. 15 and FIGS. 16A-16J conjunctively to more clearly demonstrate the present disclosure.

Referring to FIG. 15, in operation S610, a first base headshot photo is received by the system. With reference to FIG. 16A, the first base headshot photo 610 in the present embodiment is a smiling face, which exhibits a first emotion, delight or joy. In some embodiments, the first base headshot photo 610 is captured by an imaging device. Alternatively, the first base headshot photo 610 is retrieved from a memory of the system or received through an electronic transmission from a user external to the system.

In operation S620, a second base headshot photo 620 is received. With reference to FIG. 16B, the second base headshot photo 620 in the present embodiment is an angry face, which exhibits a second emotion, anger, different from the first emotion. Accordingly, unlike some existing approaches that aim at adjusting one emotion to another based on a same headshot photo, the present disclosure uses the first base headshot photo 610 to show a first basic emotion and a second base headshot photo 620 to show a second basic emotion.

In operation S630, a first derivative headshot photo 612 is generated by adjusting a facial feature of the first base headshot photo 610. The facial feature to be adjusted includes, but is not limited to, hairline, temple, eye, eyebrow, ophryon, ear, nose, cheek, dimple, philtrum, lip, mouth, chin, and forehead of the first base headshot photo 610. In an embodiment, the facial expression of the first base headshot photo 610 is adjusted by changing a dimension or size of a selected facial feature. In another embodiment, the facial expression of the first base headshot photo 610 is adjusted by changing the position, orientation, or direction of a selected facial feature. As a result, a derivative facial expression is generated by changing an adjustable factor such as the dimension, size, position, orientation, or direction of the selected facial feature.

With reference to FIG. 16C, the first derivative headshot photo 612 is generated by decreasing the dimension of the eyes on the first base headshot photo 610. In some embodiments, one or more first derivative headshot photos may be generated, each by changing one or more adjustable factors in one or more facial features of the first base headshot photo 610. Accordingly, with reference to FIG. 16D, another first derivative headshot photo 614 is generated by changing the shape of the mouth and/or the cheek on the first base headshot photo 610. With reference to FIG. 16E, yet another first derivative headshot photo 616 is generated by raising only one corner of the mouth on the first base headshot photo 610.

The first base headshot photo 610, the first derivative headshot photos 612, 614, 616 and other such first derivative headshot photos (not numbered) form a set of headshot photos 618, as illustrated in FIG. 16F. The set of head shot photos 618 exhibits the first basic emotion in different facial expressions, and thus can show different kinds or degrees of “smiling.”

In operation S640, similar to operation S630, a second derivative headshot photo is generated by adjusting a facial feature of the second base headshot photo 620. Moreover, one or more second derivative headshot photos may be generated each by changing one or more adjustable factors in one or more facial features of the second base headshot photo 620.

The second base headshot photo 620 and the one or more second derivative headshot photos (not numbered) form a set of headshot photos 628, as illustrated in FIG. 16G. The set of head shot photos 628 exhibits the second basic emotion in different facial expressions, and thus can show different kinds or degrees of “anger.”

Next, in operation S650, also referring to FIG. 16H, a first set of headshot photos 638 by selecting headshot photos from the first base headshot photo 610 and the first derivative headshot photos in the set 618, and the second base headshot photo 620 and the second derivative headshot photos in the set 628. Although in the present embodiment all of the headshot photos in the sets 618 and 628 are selected, in other embodiments, however, only a portion of the photos in the set 618 and a portion of the photos in the set 628 are selected.

Subsequently, in operation 660, a first animated content based on the first set of photos 638 is generated. The first animated content includes a display of photos selected from the first set of headshot photos 638. The selected headshot photos may be displayed one at a time in a predetermined order in an embodiment, or in an arbitrary order in another embodiment. Moreover, the selected headshot photos may each be displayed for a same duration in an embodiment, or at least one of the selected headshot photos is displayed for a different duration in another embodiment. Display of the selected headshot photos in a different order or for a different duration facilitates demonstration of a highlighted facial expression and hence may enhance the change in emotion. Accordingly, an animated content, in the form of animation or short clip, is generated. For example, with reference to FIG. 16I, the first derivative headshot photo 614 of the first base headshot photo 610 is outputted at the frame 604 of the display at the first instance of the first animated content. After the first derivative headshot photo 614 is outputted for a predetermined duration, at the second instance of the animated content, with reference to FIG. 16J, the second base headshot photo 620 is displayed in the frame 604 for the predetermined duration. As such, a change in emotion of the contact person is more accurately and vividly expressed by the first animated content. In the present embodiment, two photos 614 and 620 are selected from the first set of headshot photos 638 for the first animated content so that an abrupt change in emotion is emphasized. In other embodiments, more headshot photos in the first set of headshot photos 638 are selected for the first animated content so as to facilitate the exhibition of a smooth flow of emotion change.

In some embodiments in accordance with the present disclosure, the first animated content is displayed or played at the frame 604 repetitively. As a result, the first animated content is continuously played at the frame 604 such that when a user of the system sees the first animated content, such user may be able to discern the emotion of the contact person more accurately.

In some embodiments in accordance with the present disclosure, a second animated content different from the first animated content is generated. For example, a third base headshot photo exhibiting a third emotion different from the first and second emotions is received. A third derivative headshot photo is generated by adjusting a facial feature of the third base headshot photo. Next, a second set of photos is formed by selecting photos from the third base headshot photo and the third derivative headshot photo. Subsequently, a second animated content based on the second set of photos is generated. The selected headshot photos for the second animated content may be displayed one at a time in a predetermined order or an arbitrary order. Furthermore, at least one of the selected headshot photos for the second animated content may be displayed for a different duration.

For another example, in addition to receiving the third base headshot photo and generating the third derivative headshot phot, based on similar operations shown in FIG. 15, a fourth base headshot photo exhibiting a fourth emotion different from the first, second and third emotions is received. A fourth derivative headshot photo is generated by adjusting a facial feature of the fourth base headshot photo. Next, a second set of photos is formed by selecting photos from the third base headshot photo, the third derivative headshot photo, the fourth base headshot photo and the fourth derivative headshot photo. Subsequently, a second animated content based on the second set of photos is generated. The selected headshot photos for the second animated content may be displayed one at a time in a predetermined order or an arbitrary order. Furthermore, at least one of the selected headshot photos for the second animated content may be displayed for a different duration.

In some embodiments, the second animated content is generated by selecting photos different from photos of the first animated content. In still some embodiments, the second animated content is generated by selecting photos from the third base headshot photo, the third derivative headshot photo and the first set of headshot photos 638. Moreover, the selected photos are displayed one at a time in a predetermined order or an arbitrary order. Furthermore, at least one of the selected headshot photos for the second animated content may be displayed for a different duration.

With the first and second animated contents, the user of the system may choose to output either or both of the animated contents at a display of the system. Accordingly, the user may choose to more vividly demonstrate his/her emotions by outputting the either or both of the animated contents. Moreover, an emotion of the contact person is more accurately and vividly expressed by the change of facial expressions.

In some embodiments in accordance with the present disclosure, in one operation, the user of the system may receive a request to transmit the first animated content from another computing device. For example, a user from such another computing device is requesting an access to the first animated content, or even the basic information, of the user at the present system. The system may conduct an identification process to verify whether the use at such another computing device is a friend or an authorized user. If so, the system may choose to transmit the first animated content to such another computing device so that the user at such device will be able to perceive the emotion of the user at the present system more accurately or in a more vivid way.

In some embodiments in accordance with the present disclosure, when the user of the present system may receive a second animated content from the user at such another computing device. For example, the second animated content may demonstrate a sorrow emotion of the user at such another computing device. Thereafter, the user of the present system may feel affected by the second animated content, and decide to alter the first animated content. For example, the first animated content may be changed from displaying a smiling face to a sad face in response to the second animated content. Accordingly, the present disclosure provides a method and system to generate an animated content to be displayed or transmitted to another device to be displayed. Consequently, the change of facial expressions of the headshot photos in an animated content helps users to perceive emotions of other users more accurately or in a more vivid way.

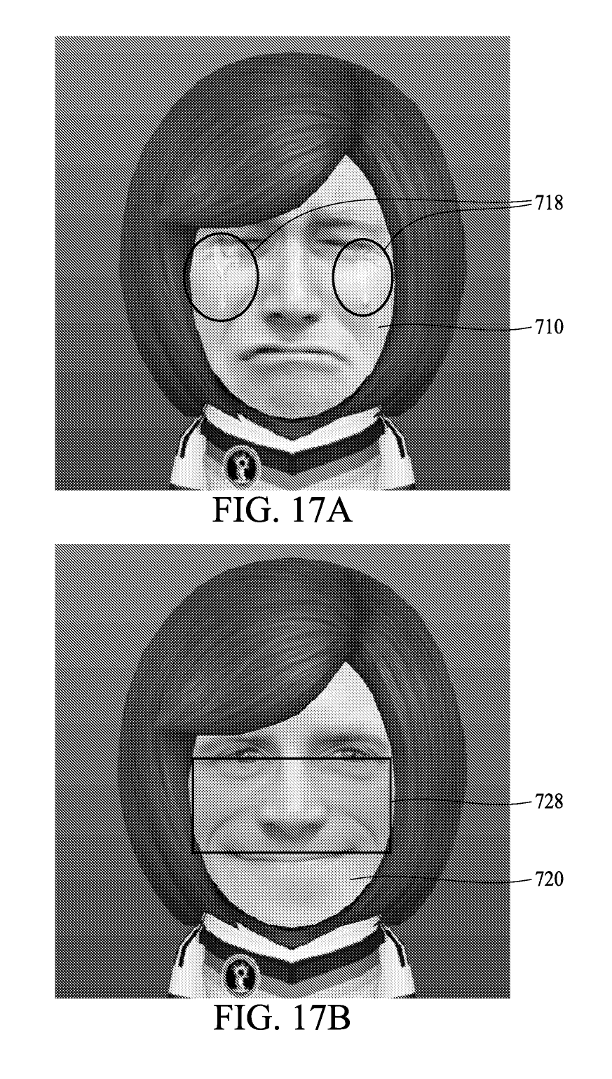

FIGS. 17A and 17B illustrate additional characteristics for a base headshot photo, in accordance with some embodiments of the present disclosure. The additional characteristics add more fun to an animated content, which in turn may more accurately or vividly reveal one's emotion.

Referring to FIG. 17A, in adjusting a base or a derivative headshot photo 710, an object 718 having a visual effect on a selected facial feature of the headshot photo 710 is added. In the present embodiment, teardrops are added to emphasize a sad emotion. In some embodiments, objects having a visual effect may include but are not limited to crowfeet on the forehead, protruding teeth, swollen veins, erupting zits, an eyemask, a mole, and a dimple on the face.

Referring to FIG. 17B, in adjusting a base or a derivative headshot photo 720, a selected facial feature of the headshot photo 720, in part or whole, is colored. In the present embodiment, an area between eyes and lip is colored, for example, red to show a drunken or ablush state.

Apart from the visual effect and coloring effect, in some embodiments, adjusting a base or a derivative headshot photo may include providing or changing a hairstyle for at least one selected headshot photos for an animated content. As a result, a more vivid and interesting expression of an emotion is generated.

Embodiments of the present disclosure provide a method for generating an animated content. The method comprises the following operations. In one operation, a first base headshot photo is received, the first base headshot photo exhibiting a first emotion. In one operation, a second base headshot photo is received, the second base headshot photo exhibiting a second emotion different from the first emotion. In one operation, a first derivative headshot photo is generated by adjusting a facial feature of the first base headshot photo. In one operation, a second derivative headshot photo is generated by adjusting a facial feature of the second base headshot photo. In one operation, a first set of photos is formed by selecting photos from the first base headshot photo, the second base headshot photo, the first derivative headshot photo and the second derivative headshot photo. In one operation, a first animated content is generated based on the first set of photos.

Embodiments of the present disclosure also provide a system for generating an animated content. The system comprises a memory and one or more processors. In addition, the system includes one or more programs stored in the memory and configured for execution by the one or more processors. The one or more programs include instructions that when executed, triggers the following operations. In one operation, a first base headshot photo is received, the first base headshot photo exhibiting a first emotion. In one operation, a second base headshot photo is received, the second base headshot photo exhibiting a second emotion different from the first emotion. In one operation, a first derivative headshot photo is generated by adjusting a facial feature of the first base headshot photo. In one operation, a second derivative headshot photo is generated by adjusting a facial feature of the second base headshot photo. In one operation, a first set of photos is formed by selecting photos from the first base headshot photo, the second base headshot photo, the first derivative headshot photo and the second derivative headshot photo. In one operation, a first animated content is generated based on the first set of photos.

Some embodiments of the present disclosure provide a non-transitory computer readable storage medium storing one or more programs is provided. The one or more programs includes instructions, which when executed by a computing device, causes the computing device to perform the following operations. In one operation, a first base headshot photo is received, the first base headshot photo exhibiting a first emotion. In one operation, a second base headshot photo is received, the second base headshot photo exhibiting a second emotion different from the first emotion. In one operation, a first derivative headshot photo is generated by adjusting a facial feature of the first base headshot photo. In one operation, a second derivative headshot photo is generated by adjusting a facial feature of the second base headshot photo. In one operation, a first set of photos is formed by selecting photos from the first base headshot photo, the second base headshot photo, the first derivative headshot photo and the second derivative headshot photo. In one operation, a first animated content is generated based on the first set of photos.

Although the present disclosure and its advantages have been described in detail, it should be understood that various changes, substitutions and alterations cancan be made herein without departing from the spirit and scope of the present disclosure as defined by the appended claims. For example, many of the processes discussed above cancan be implemented in different methodologies and replaced by other processes, or a combination thereof.

Moreover, the scope of the present application is not intended to be limited to the particular embodiments of the process, machine, means, methods and steps described in the specification. As one of ordinary skill in the art will readily appreciate from the disclosure of the present disclosure, processes, machines, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, means, methods, or steps.

What is claimed is:

1. A method for generating an animated content, the method comprising:
receiving a first base headshot photo, the first base headshot photo exhibiting a first emotion;
receiving a second base headshot photo, the second base headshot photo exhibiting a second emotion different from the first emotion;
generating a first derivative headshot photo by adjusting a facial feature of the first base headshot photo;
generating a second derivative headshot photo by adjusting a facial feature of the second base headshot photo;
forming a first set of photos by selecting photos from the first base headshot photo, the second base headshot photo, the first derivative headshot photo and the second derivative headshot photo; and
generating a first animated content based on the first set of photos.

2. The method according to claim 1, wherein generating the first animated content includes:
displaying the first set of photos one at a time in a predetermined order.

3. The method according to claim 2 further comprising:
displaying one of the first set of photos for a different duration.

4. The method according to claim 1, wherein generating the first animated content includes:
displaying the first set of photos one at a time in an arbitrary order.

5. The method according to claim 4 further comprising:
displaying one of the first set of photos for a different duration.

6. The method according to claim 1, wherein the facial feature of the first or second base headshot photo is selected from a group consisting of hairline, temple, eye, eyebrow, ophryon, ear, nose, cheek, dimple, philtrum, lip, mouth, chin, and forehead.

7. The method according to claim 1 further comprising:
providing a different hairstyle for one of the first set of photos.

8. The method according to claim 1, wherein adjusting the facial feature of the first or second base headshot photo includes:
changing a dimension of the facial feature being adjusted.

9. The method according to claim 1, wherein adjusting the facial feature of the first or second base headshot photo includes:
changing a position of the facial feature being adjusted.

10. The method according to claim 1, wherein adjusting the facial feature of the first or second base headshot photo includes:
adding an additional characteristic to the first base headshot photo or the second base headshot photo.

11. The method according to claim 10, wherein adding an additional characteristic includes:
coloring the facial feature being adjusted.

12. The method according to claim 10, wherein adding an additional characteristic includes:
adding an object having a visual effect on the facial feature being adjusted.

13. The method according to claim 1 further comprising:
receiving a third base headshot photo, the third base headshot photo exhibiting a third emotion different from the first and second emotions;
generating a third derivative headshot photo by adjusting a facial feature of the third base headshot photo;
forming a second set of photos by selecting photos from the third base headshot photo and the third derivative headshot photo; and
generating a second animated content based on the second set of photos.

14. The method according to claim 13, wherein generating the second animated content includes:
displaying the second set of photos one at a time in an arbitrary order.

15. The method according to claim 13 further comprising:
displaying one of the second set of photos for a different duration.

16. The method according to claim 13, wherein adjusting the facial feature of the third base headshot photo includes:
changing a dimension of the facial feature being adjusted.

17. The method according to claim 13, wherein adjusting the facial feature of the third base headshot photo includes:
changing a position of the facial feature being adjusted.

18. The method according to claim 13, wherein adjusting the facial feature of the third base headshot photo includes:
adding an additional characteristic to the third base headshot photo.

19. A system for generating animated content, comprising:
a memory;
one or more processors; and
one or more programs stored in the memory and configured for execution by the one or more processors, the one or more programs including instructions for:
receiving a first base headshot photo, the first base headshot photo exhibiting a first emotion;
receiving a second base headshot photo, the second base headshot photo exhibiting a second emotion different from the first emotion;
generating a first derivative headshot photo by adjusting a facial feature of the first base headshot photo;
generating a second derivative headshot photo by adjusting a facial feature of the second base headshot photo;
forming a first set of photos by selecting photos from the first base headshot photo, the second base headshot photo, the first derivative headshot photo and the second derivative headshot photo; and
generating a first animated content based on the first set of photos.

20. A non-transitory computer readable storage medium storing one or more programs, the one or more programs comprising instructions, which when executed by a computing device, causes the computing device to:
receive a first base headshot photo, the first base headshot photo exhibiting a first emotion;
receive a second base headshot photo, the second base headshot photo exhibiting a second emotion different from the first emotion;
generate a first derivative headshot photo by adjusting a facial feature of the first base headshot photo;
generate a second derivative headshot photo by adjusting a facial feature of the second base headshot photo;
form a first set of photos by selecting photos from the first base headshot photo, the second base headshot photo, the first derivative headshot photo and the second derivative headshot photo; and
generate a first animated content based on the first set of photos.
